(19) United States
(12) Patent Application Publication
(10) Pub. No.: US 2011/0311932 A1
(43) Pub. Date: Dec. 22, 2011

(54) ORTHODONTIC DEVICE

(75) Inventor: Stanley Newton Parker, Largo, FL (US)

(73) Assignee: PARKER ORTHODONTICS, Indian Rocks Beach, FL (US)

(21) Appl. No.: 12/857,538

(22) Filed: Aug. 16, 2010

Related U.S. Application Data
(60) Provisional application No. 61/356,598, filed on Jun. 19, 2010.

(51) Int. Cl. A61C 7/28

(52) U.S. Cl. 433/9

(57) ABSTRACT

Systems, methods and apparatus are provided through which in some implementations at least one tooth-bonding-pad is directly attached to an archwire.

### RELATED APPLICATION

This application claims the benefit of U.S. Provisional Application Ser. No. 61/356,598 titled “Orthodontic Device” filed 19 Jun. 2010 under 35 U.S.C. 119(e).

### FIELD

This disclosure relates generally to orthodontic devices, and more particularly to orthodontic archwire devices.

### BACKGROUND

In orthodontics, an orthodontic archwire is ligated to a number of orthodontic brackets, each of which has a tooth-bonding-pad as a part of a bracket. An orthodontic archwire is a wire conforming to the alveolar or dental arch that can be used with dental tooth-bonding pads and brackets as a source of force in correcting irregularities in the position of the teeth. The dental tooth-bonding pads are attached to the brackets and the brackets are attached to the archwire. The archwire is attached to the brackets by an Orthodontist in the mouth of a patient.

### BRIEF DESCRIPTION OF THE DRAWINGS

FIG. 1 is a block diagram of an overview of a unitary tooth-bonding-pad/archwire apparatus, according to an implementation;

FIG. 2 is a block diagram of an overview of a unitary tooth-bonding-pad/archwire apparatus, according to an implementation and illustrating dimensions between tooth-bonding-pads;

FIG. 3 is an occlusal view of a cross section block diagram of an apparatus according to an implementation illustrating an archwire exiting or protruding from a side of a tooth-bonding-pad;

FIG. 4 is a distal or mesial view of a cross section block diagram of an apparatus according to an implementation illustrating an archwire exiting or protruding from a side of a tooth-bonding-pad;

FIG. 5 is a buccal view of a cross section block diagram of an apparatus according to an implementation illustrating an archwire exiting or protruding from a side of a tooth-bonding-pad;

FIG. 6 is an occlusal view of a cross section block diagram of an apparatus according to an implementation illustrating an archwire exiting or protruding from an interior of a tooth-bonding-pad;

FIG. 7 is a distal or mesial view of a cross section block diagram of an apparatus according to an implementation illustrating an archwire exiting or protruding from an interior of a tooth-bonding-pad;

FIG. 8 is a buccal view of a cross section block diagram of an apparatus according to an implementation illustrating an archwire exiting or protruding from an interior of a tooth-bonding-pad;

FIG. 9 is an occlusal view of a cross section block diagram of an apparatus according to an implementation illustrating an archwire removeably attached to a side of a tooth-bonding-pad;

FIG. 10 is a distal or mesial view of a cross section block diagram of an apparatus according to an implementation illustrating an archwire removeably attached to a side of a tooth-bonding-pad;

FIG. 11 is a buccal view of a cross section block diagram of an apparatus according to an implementation illustrating an archwire removeably attached to a side of a tooth-bonding-pad;

FIG. 12 is an occlusal view of a cross section block diagram of an apparatus according to an implementation illustrating an archwire indirectly attached to a side of a tooth-bonding-pad;

FIG. 13 is a distal or mesial view of a cross section block diagram of an apparatus according to an implementation illustrating an archwire removeably attached to a side of a tooth-bonding-pad;

FIG. 14 is a buccal view of a cross section block diagram of an apparatus according to an implementation illustrating an archwire removeably attached to a side of a tooth-bonding-pad;

FIG. 15 is a block diagram of a molar unitary tooth-bonding-pad/archwire apparatus applied to a molar tooth, according to an implementation;

FIG. 16 is an occlusal-view block diagram of a unitary tooth-bonding-pad/archwire apparatus applied to a molar tooth, a bicuspid tooth and a canine tooth, according to an implementation;

FIG. 17 is a buccal-view block diagram of a unitary tooth-bonding-pad/archwire apparatus applied to a molar tooth, a bicuspid tooth and a canine tooth, according to an implementation;

FIG. 18 is a side-view block diagram of a unitary tooth-bonding-pad/archwire apparatus applied to a bicuspid tooth, according to an implementation having a short stand-off apparatus;

FIG. 19 is a side-view block diagram of a unitary tooth-bonding-pad/archwire apparatus applied to a bicuspid tooth, according to an implementation having a long stand-off apparatus;

FIG. 20 is a side-view block diagram of a unitary tooth-bonding-pad/archwire apparatus, according to an implementation having no standoff apparatus;

FIG. 21 is a side-view block diagram of a unitary tooth-bonding-pad/archwire apparatus, according to an implementation having no standoff apparatus;

FIG. 22 is a table of spacing between tooth-bonding-pads in an upper archwire for a human, according to an implementation;

FIG. 23 is a table of spacing between tooth-bonding-pads in a lower archwire for a human, according to an implementation;

FIG. 24 is a flowchart of a method to fabricate a unitary tooth-bonding-pad/archwire apparatus according to an implementation;

FIG. 25 is a flowchart of a method to fabricate a unitary tooth-bonding-pad/archwire apparatus according to an implementation;

FIG. 26 is a flowchart of a method to implement a unitary tooth-bonding-pad/archwire apparatus, according to an implementation before application of removable orthodontic appliance systems;

FIG. 27 is a flowchart of a method to implement a unitary tooth-bonding-pad/archwire apparatus, to correct orthodontic relapse;

FIG. 28 is a flowchart of a method to implement a unitary tooth-bonding-pad/archwire apparatus, to facilitate the application of interceptive removable orthodontic devices on patients who are in a mixed dentition age range;

FIG. 29 is a flowchart of a method to implement a unitary tooth-bonding-pad/archwire apparatus, to correct a minor orthodontic malocclusion; and

FIG. 30 is a flowchart of a method to implement a unitary tooth-bonding-pad/archwire apparatus, in coordination with application of crowns and abutments.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, physical and other changes may be made without departing from the scope of the implementations. The following detailed description is, therefore, not to be taken in a limiting sense.

In one aspect, at least one tooth-bonding-pad is directly attached to an archwire.

In one other aspect, an apparatus consists of an archwire and a plurality of tooth-bonding-pads. In some implementations, each of the plurality of tooth-bonding-pads is permanently fabricated to the archwire at fixed positions of the archwire. In some implementations, each of the plurality of tooth-bonding-pads is permanently fabricated into the archwire at fixed positions of the archwire. In some implementations, each of the plurality of tooth-bonding-pads is permanently fabricated onto the archwire at fixed positions of the archwire.

In another aspect, an apparatus consists essentially of an archwire and a plurality of tooth-bonding-pads. In some implementations, each of the plurality of tooth-bonding-pads is permanently fabricated into the archwire at fixed positions of the archwire.

In yet another aspect, an apparatus includes an archwire and a plurality of tooth-bonding-pads. In some implementations, each of the plurality of tooth-bonding-pads is permanently fabricated into the archwire at fixed positions of the archwire.

In still yet another aspect, an apparatus consists of an archwire and at least one tooth-bonding-pad directly attached to the archwire.

In still yet a further aspect, an apparatus consists essentially of an archwire and at least one tooth-bonding-pad directly attached to the archwire.

In still a further aspect, an apparatus comprises an archwire and at least one tooth-bonding-pad directly attached to the archwire.

In still another aspect, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and attaching permanently an archwire to the exterior surface of each of the plurality of the tooth-bonding-pads in a plane.

In a further aspect, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and forming an archwire to an exterior surface of each of the plurality of the tooth-bonding-pads in a horizontal plane.

In yet a further aspect, an orthodontic apparatus having an archwire and at least one tooth-bonding-pad does not include an orthodontic bracket.

Apparatus, systems, and methods of varying scope are described herein. In addition to the aspects and advantages described herein, further aspects and advantages will become apparent by reference to the drawings and by reading the detailed description that follows.

The detailed description is divided into four sections. In the first section, a system level overview is described. In the second section, apparatus of implementations are described. In the third section, implementations of methods are described. Finally, in the fourth section, a conclusion of the detailed description is provided.

### System Level Overview

A system level overview of the operation of an implementation is described in this section of the detailed description.

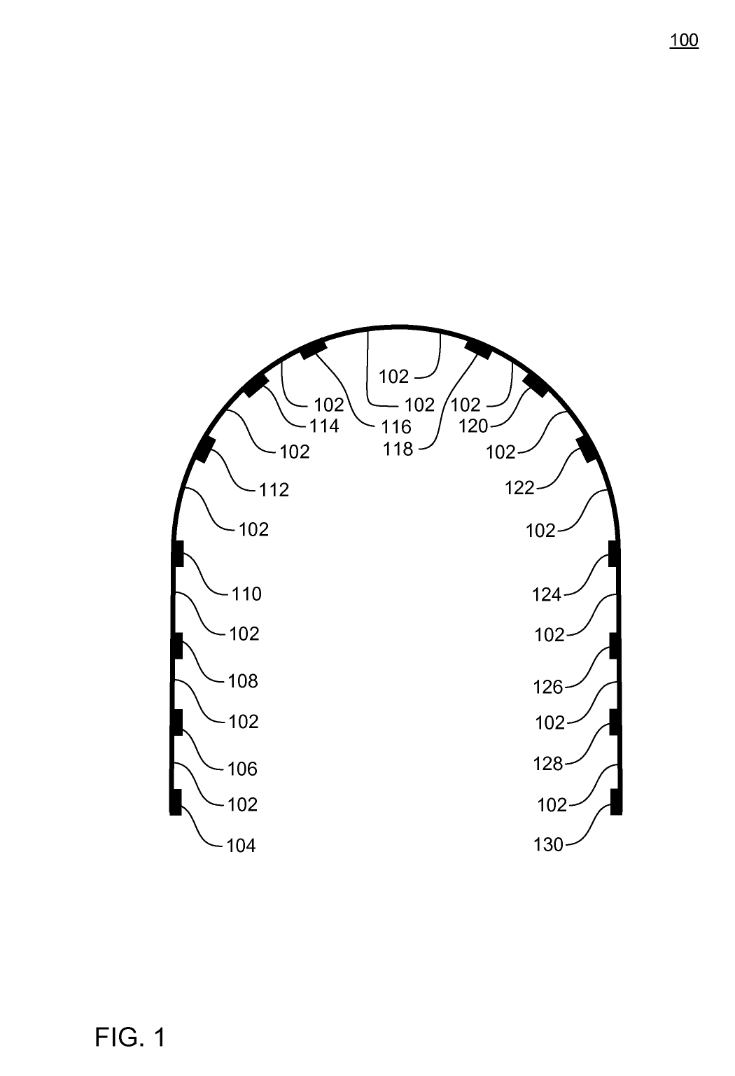

FIG. 1 is a block diagram of an overview of a unitary tooth-bonding-pad/archwire apparatus 100, according to an implementation. Apparatus 100 can be described as a single-bonded archwire.

Apparatus 100 includes an archwire 102 and a plurality of tooth-bonding-pads 104, 106, 108, 110, 112, 114, 116, 118, 120, 122, 124, 126, 128 and 130. Each of the plurality of tooth-bonding-pads 104-130 are permanently fabricated to the archwire 102 at fixed positions of the archwire 102.

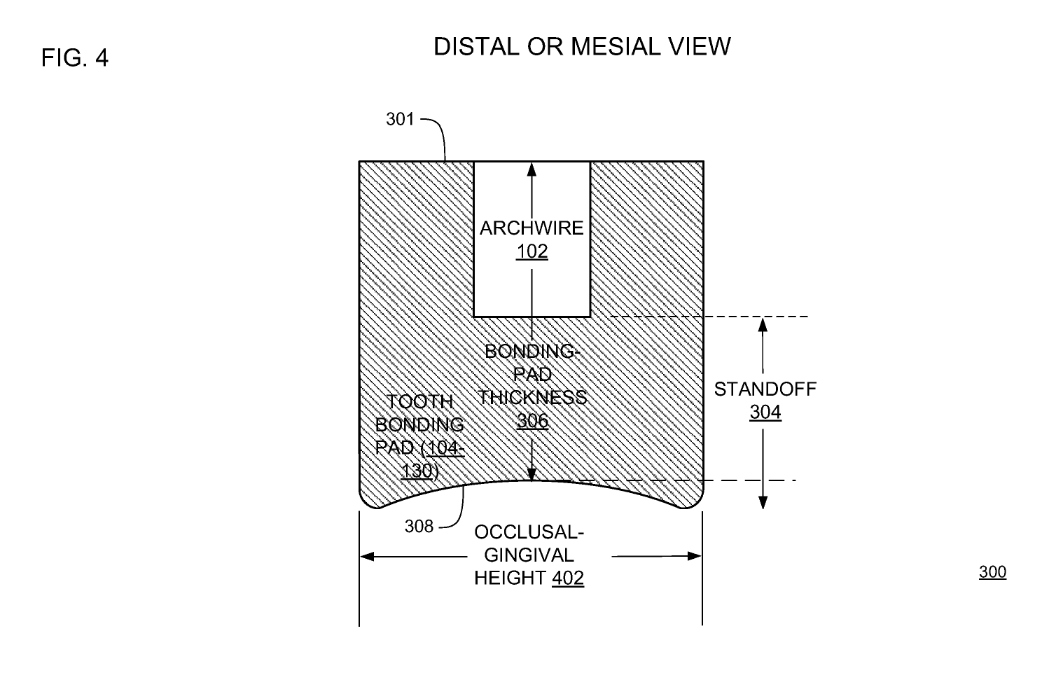

An important feature in some implementations of apparatus 100 is that the apparatus 100 does not have or include an orthodontic bracket. The lack of an orthodontic bracket simplifies the fabrication of the apparatus 100. The lack of an orthodontic bracket also improves the comfort of a patient to which the apparatus 100 is applied. The absence of an orthodontic bracket provides a lower physical profile and a smaller height dimension, as shown in FIG. 4. The lower physical profile of apparatus 100 positions the archwire 102 further away from the inside of the cheek of the patient to which the apparatus 100 is applied, thus reducing friction of the inside of the cheek on the archwire 102, and thus improving comfort of the patient to which the apparatus 100 is applied.

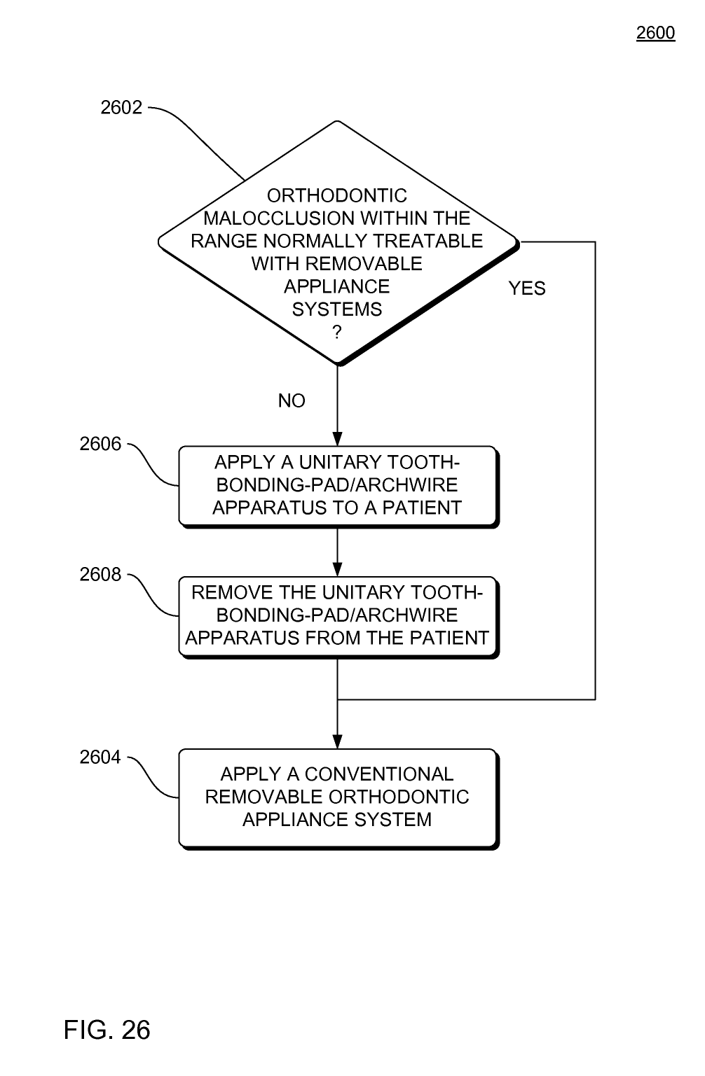

Apparatus 100 can be implemented as an enabling appliance for orthodontic patients who, without prior treatment using apparatus 100, would not be practical candidates for complete and finishing orthodontic treatment with other removable orthodontic appliance systems, as described in greater detail in FIG. 26 below.

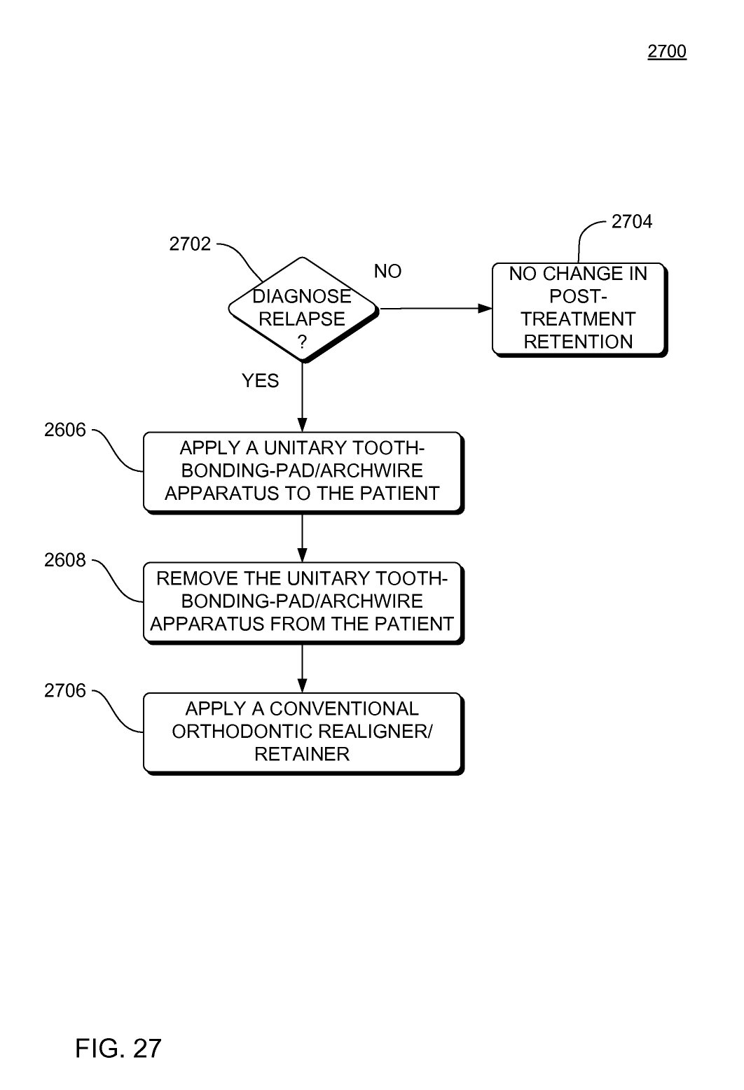

For correction of orthodontic relapse, where the degree of relapse is outside the range of treatment of a conventional realigner-retainer appliance, apparatus 100 is implemented to bring the degree of correction needed back within range of a realigner or a retainer, as described in greater detail in FIG. 27.

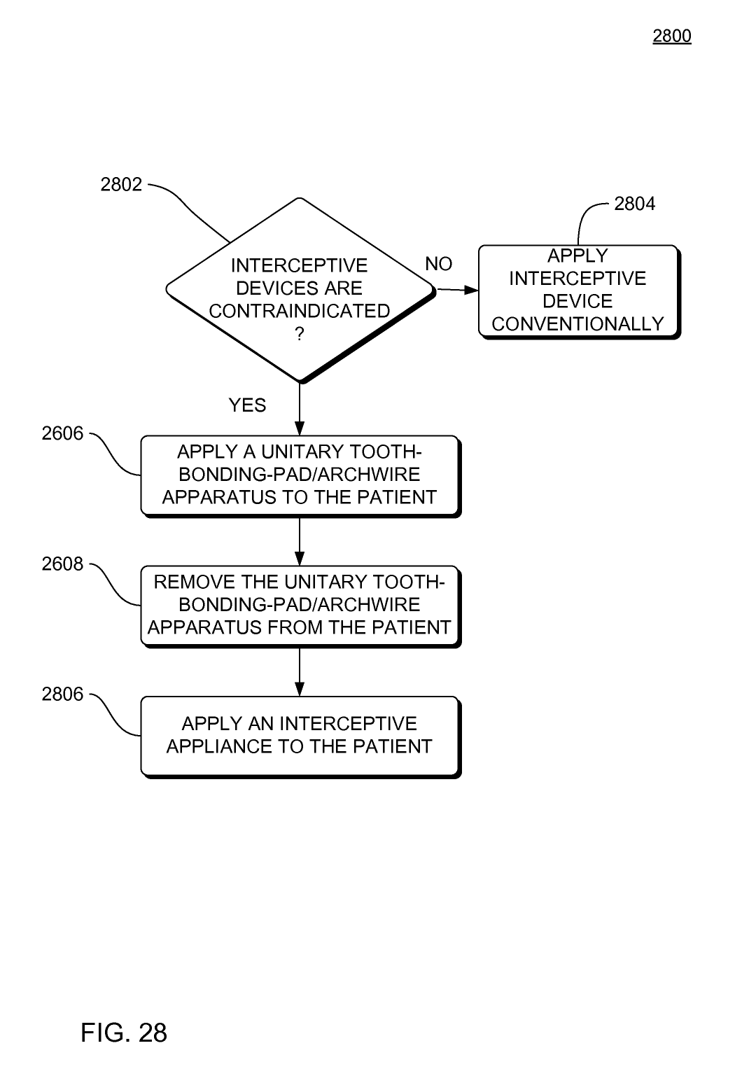

Apparatus 100 can be implemented in order to facilitate the implementation of interceptive removable orthodontic devices for patients in a mixed dentition age range. For patients who have one or more teeth positioned such that the implementation of interceptive devices would be contraindicated, these problematically positioned teeth can be moved into positions by apparatus 100 in which the positions permit the implementation of these interceptive appliances. Interceptive orthodontic appliances include Frankel orthodontic appliances, Schwarz orthodontic appliances and Bionator orthodontic appliances, as described in greater detail in FIG. 28.

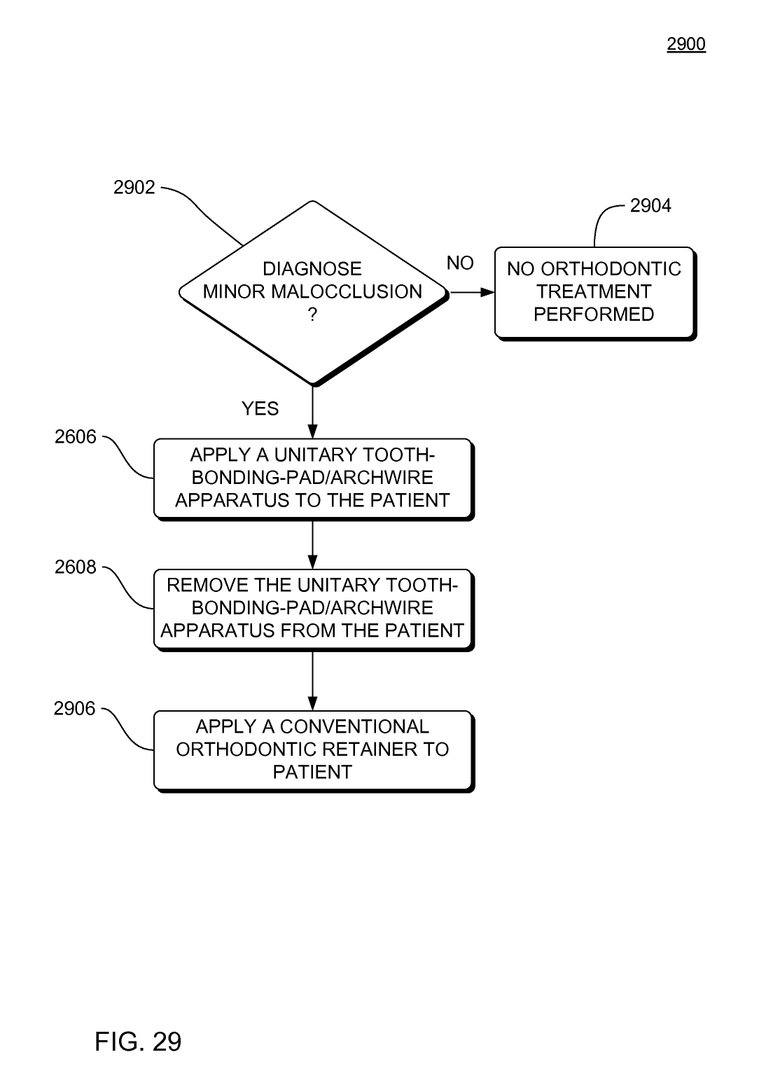

In addition apparatus 100 can be implemented as a single appliance treatment for complete orthodontic treatment in cases of minor orthodontic malocclusions. For example, in cases where a dental malocclusion consists of only minor tooth displacements, such as buccal-lingual displacements, rotations, tipping, and vertical height discrepancies, complete orthodontic treatment can be obtained with the application of apparatus 100. Following completion of orthodontic treatment using apparatus 100, any conventional retainer, such as a Hawley orthodontic appliance can be implemented to retain the orthodontic result, as described in greater detail in FIG. 29.

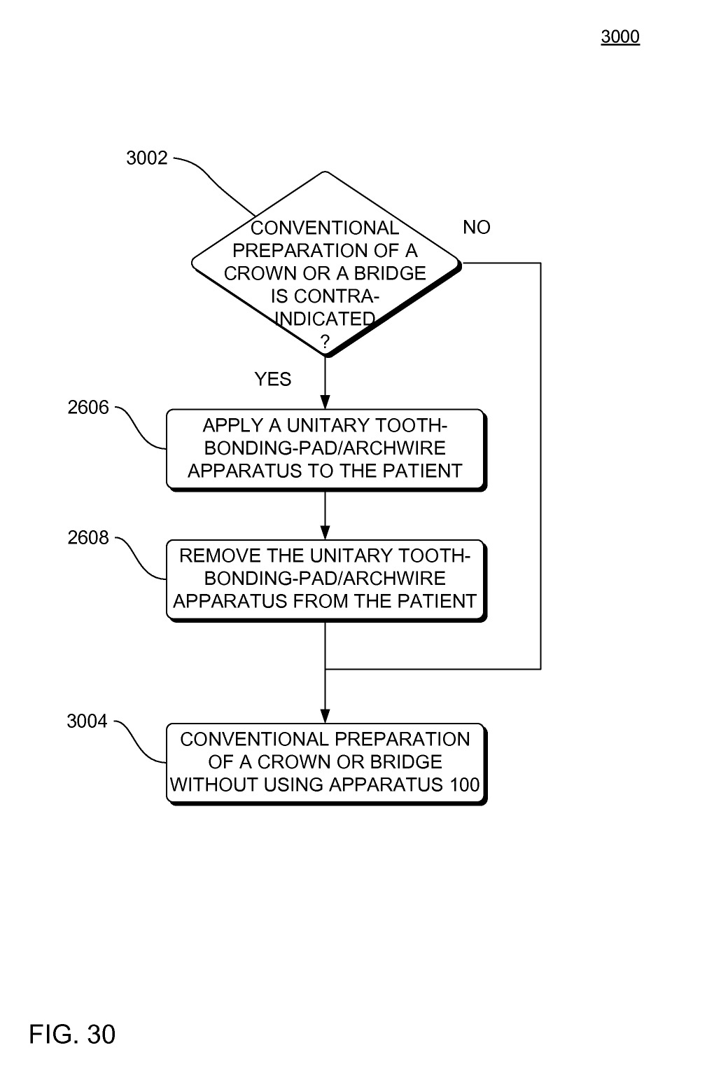

Apparatus 100 can be implemented prior to crown and bridge work in dentistry. When one or more of teeth that are to be prepared for crowns or as abutments for bridgework are in less than ideal positions, apparatus 100 can be implemented to better position these teeth for stress bearing associated with chewing forces, and also to allow for a more aesthetically appearing cosmetic result. Short term correction involving apparatus 100 aligns the anterior teeth so that conservative crown preparation will allow for a cosmetically ideal result, as described in greater detail in FIG. 30.

In some implementations of apparatus 100, the materials of the archwire 102 and/or the tooth-bonding-pads 104-130 include 0.0-5.5% iron, 7.0 to 9.0% aluminum, 3.0-5.5% nickel, 1.0-8.0% zinc, 0-2.5% manganese and the remainder being copper, or any other material that will work with conventional approved orthodontic bonding systems implemented for orthodontic bracket placement. The geometry of the tooth-bonding-pads 104-130 are of standardized bracket base form, derived from statistical tooth geometry data for labial and buccal tooth surfaces.

In the implementation shown in FIG. 1, the apparatus 100 includes 14 tooth-bonding-pads 104-130. However, other implementations can be fabricated, with any number of tooth-bonding-pads, such as 10 tooth-bonding-pads, 11 tooth-bonding-pads, 12 tooth-bonding-pads, 13 tooth-bonding-pads, 15 tooth-bonding-pads or 16 tooth-bonding-pads. The disclosure herein is not limited by the number of tooth-bonding-pads.

The locations for the tooth-bonding-pads 104-130 on the archwire 102 in FIG. 1 is one implementation. Variation among population bases and future applications associated with evolving treatment modalities alter the exact location of these tooth-bonding-pads 104-130 on the archwire 102. Additionally, the archwire 102 and tooth-bonding-pads 104-130 can be custom fabricated for a selected patient based on full arch impressions, optical or infrared scans, or calibrated photography, thus many variations in the locations for the tooth-bonding-pads 104-130 on the archwire 102 are contemplated.

In some implementations, the contours of the tooth-bonding-pads 104-130 are in accordance with existing statistical norms of the labial and buccal surfaces of the teeth. The size of the tooth-bonding-pads 104-130 are varied slightly to allow for the different force per unit deflection of the different diameter archwires.

In some implementations of apparatus 100, each of the tooth-bonding-pads have an orientation to the archwire 102 such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In further implementations, the tooth-bonding-pads are accurately appositioned with labial and buccal aspects at occlusal-gingival center and mesial-distal center to the extent that the human teeth that are not in orthodontically correct positions will experience corrective orthodontic forces moving the human teeth toward orthodontically correct positions.

In some implementations of apparatus 100, each of the tooth-bonding-pads includes at least one contour of each of the tooth-bonding-pads being produced from existing statistical norms of the labial and buccal surfaces of the teeth.

In some implementations of apparatus 100, the archwire 102 includes a nickel-titanium (NiTi) alloy metal. In some implementations of apparatus 100, the archwire 102 includes a thermally activated nickel-titanium (NiTi) alloy metal. In some implementations of the thermally activated NiTi alloy, force activation occurs at approximately 27 degrees Celsius and approximately 81 degrees Fahrenheit. Other metals that the archwire 102 can be made of include beta-Titantium, beta-Titantium-nickel, Titantium-carbide, Titanium Molybdenum alloys, stainless steel and/or nickel-cobalt alloys. In some implementations of apparatus 100, the archwire 102 includes stainless steel. In some implementations of apparatus 100, the archwire 102 includes gold. In some implementations of apparatus 100, the archwire 102 includes ceramic coated nickel titanium and stainless steel.

In some implementations of apparatus 100, the archwire 102 includes a diameter selected from the group of diameters consisting of 0.012 inches round, 0.014 inches round, 0.016 inches round, and 0.016×0.016 inches rectangular cross section.

In some implementations of apparatus 100, the archwire 102 includes a tooth-color as a result of manufacturing with epoxy coatings or other tooth-colored surfaces. Tooth-bonding-pads 104, 106, 108, 110, 112, 114, 116, 118, 120, 122, 124, 126, 128 and 130 can be removeably attached to any surface of a tooth.

While the system 100 is not limited to any particular archwire 102 and tooth-bonding-pads 104-130, for sake of clarity a simplified archwire 102 and tooth-bonding-pads 104-130 are described.

### Apparatus Implementations

In the previous section, a system level overview of the operation of an implementation was described. In this section, the particular apparatus of such an implementation are described by reference to a series of diagrams.

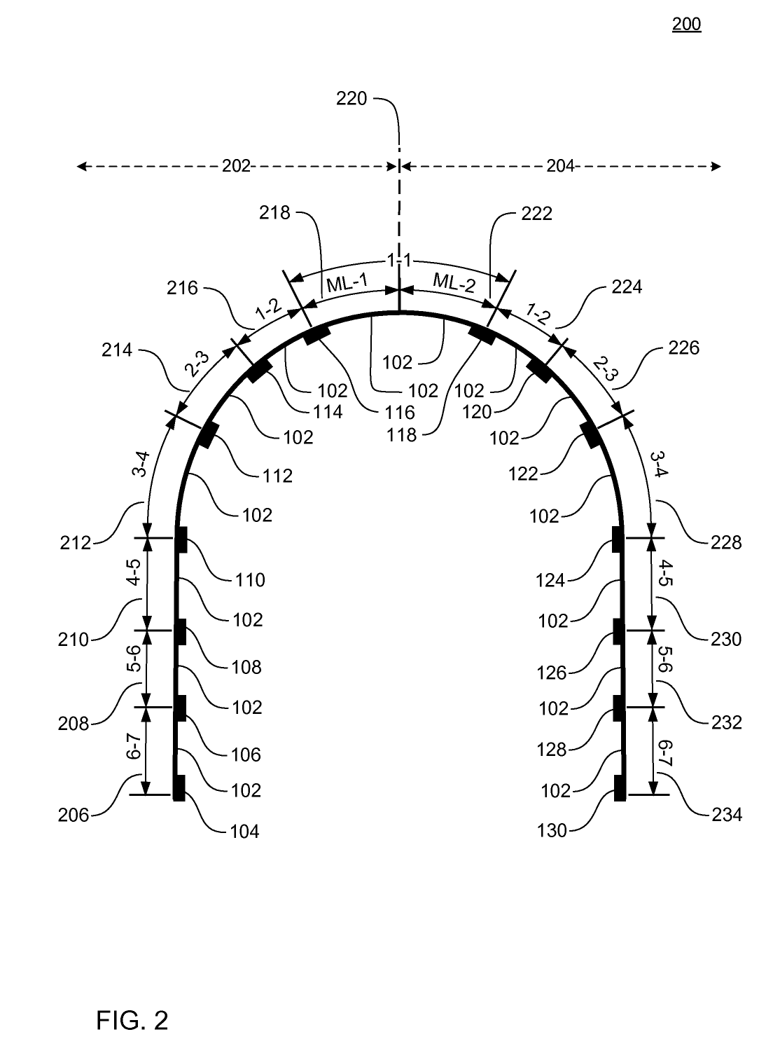

FIG. 2 is a block diagram of an overview of a unitary tooth-bonding-pad/archwire apparatus 200, according to an implementation and illustrating dimensions between tooth-bonding-pads. Apparatus 200 is a unitary tooth-bonding-pad/archwire apparatus that does not have or include an orthodontic bracket, which as a result of the absent orthodontic bracket can be fabricated easily, simply and inexpensively, and that has a low physical profile and a smaller height dimension that positions the archwire 102 further away from the inside of the cheek of a patient to which the apparatus 200 is applied, thus reducing friction of the inside of the cheek on the archwire, and thus improving comfort of the patient to which the apparatus 200 is applied.

Each archwire includes two sides 202 and 204.

In side 202, the fixed dimensions between the centers of tooth-bonding-pads 104 and 106 is “space 6-7” 206, the fixed dimensions between the centers of tooth-bonding-pads 106 and 108 is “space 5-6” 208, the fixed dimensions between the centers of tooth-bonding-pads 108 and 110 is “space 4-5” 210, the fixed dimensions between the centers of tooth-bonding-pads 110 and 112 is “space 3-4” 212, the fixed dimensions between the centers of tooth-bonding-pads 112 and 114 is “space 2-3” 214, the fixed dimensions between the centers of tooth-bonding-pads 114 and 116 is “space 1-2” 216, the fixed dimensions between the centers of tooth-bonding-pad 116 and the midline 220 of the archwire 200 is “ML-1” 218.

In side 204, the fixed dimensions between the midline 220 and the center of tooth-bonding-pad 118 is “ML-2” 222, the fixed dimensions between the centers of tooth-bonding-pads 118 and 120 is “space 1-2” 224, the fixed dimensions between the centers of tooth-bonding-pads 120 and 122 is “space 2-3” 226, the fixed dimensions between the centers of tooth-bonding-pads 122 and 124 is “space 3-4” 228, the fixed dimensions between the centers of tooth-bonding-pads 124 and 126 is “space 4-5” 230, the fixed dimensions between the centers of tooth-bonding-pads 126 and 128 is “space 5-6” 232, the fixed dimensions between the centers of tooth-bonding-pads 128 and 130 is “Space 6-7” 234.

In the implementation illustrated in FIG. 2, each side 202 and 204, is symmetrical. The geometry and the dimensions of the archwire 102 and the tooth-bonding-pads 104-130 are symmetrical between the two sides 202 and 204, and also the positions of the tooth-bonding-pads 104-130 on the archwire 102 are symmetrical between the two sides 202 and 204. Because of the symmetry of sides 202 and 204, “Space 6-7” 206 has the same dimensions as “Space 6-7” 234, “Space 5-6” 208 has the same dimensions as “Space 5-6” 232, “Space 4-5” 210 has the same dimensions as “Space 4-5 230, “Space 3-4” 212 has the same dimensions as “Space 3-4” 228, “Space 2-3” 214 has the same dimensions as “Space 2-3” 226, “Space 1-2” 216 has the same dimensions as “Space 1-2” 224 and “ML-1” 218 has the same dimensions as “ML-2” 222.

Other implementations of apparatus 200 that are not illustrated are asymmetrical in one or more aspects.

In some implementations, tooth-bonding-pads 106 and 128 for the first permanent molars have a thinner thickness than the thickness for the tooth-bonding-pads in the close vicinity, such as tooth-bonding-pads 104 and 108, and 130 and 126 because in some patients, the first buccal surfaces of the first permanent molars is more pronounced or protruding than the first buccal (outside) surfaces of the adjacent teeth. In some implementations tooth-bonding-pads 112 and 122 for the canine teeth have a thinner thickness than the thickness for the tooth-bonding-pads in the close vicinity, such as tooth-bonding-pads 110 and 114, and 124 and 120 because in some patients, the first buccal surfaces of the canine teeth is more pronounced or more protruding than the first buccal surfaces of the adjacent teeth.

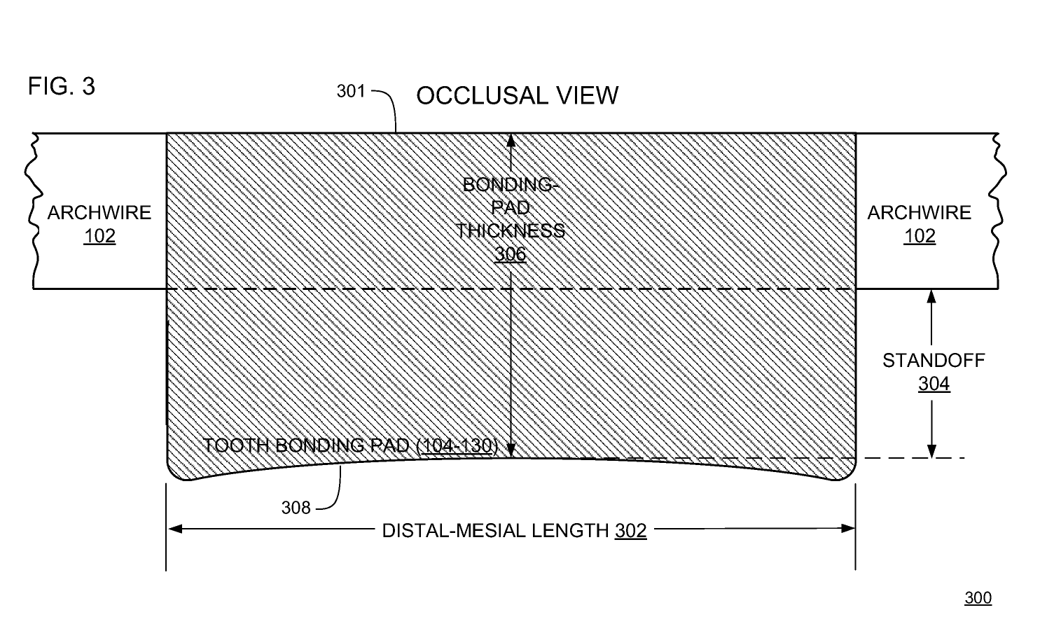

FIG. 3 is an occlusal view of a cross section block diagram of apparatus 300 according to an implementation illustrating an archwire exiting or protruding from a side of a tooth-bonding-pad. Apparatus 300 is a unitary tooth-bonding-pad/archwire apparatus that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the apparatus 300 is applied, thus reducing friction of the inside of the cheek on the archwire 102, and thus improving comfort of the patient to which the apparatus 300 is applied.

In apparatus 300, the archwire 102 is permanently fabricated into the side 301 of the matter of the tooth-bonding-pad. The tooth-bonding-pad in apparatus 300 is any one of the tooth-bonding-pads 104-130 shown in FIG. 1 and FIG. 2. In apparatus 300, most of the outside surface of the archwire 102 that is in close proximity to the tooth-bonding-pads 104-130 is fabricated into the tooth-bonding-pads 104-130. In the implementation shown in FIG. 3, the tooth-bonding-pad includes a mesial-distal length 302 in a range of 1.5 milimeters (mm) to 3.0 mm, a standoff 304 in the range of 0.1 mm and 2.0 mm and a bonding-pad thickness 306 in a range of 0.10 mm to 2.0 mm. In no case is the bonding-pad thickness 306 greater than the standoff 304 plus the diameter of the archwire 102. However, the disclosure herein is not limited to any particular dimensions of the mesial-distal length 302, standoff 304, bonding-pad thickness 306, tooth-bonding-pads 104-130 or the archwire 102.

In apparatus 300, most of the outside surface of the archwire 102 is fabricated into the tooth-bonding-pads 104-130, as described in greater detail in FIG. 4.

The absence of an orthodontic bracket in apparatus 300 provides a lower profile and a smaller bonding-pad thickness 306. The smaller bonding-pad thickness 306 of apparatus 300 positions the archwire 102 closer to the gingival and thus further away from the inside of the cheek of the patient, thus reducing friction between the inside of the cheek and the archwire 102, and therefore improving comfort of the patient.

Some implementations, a surface 308 of the tooth-bonding-pad 104-130 that can contact a tooth is microetched by a chemical process to condition the tooth-bonding-pad for better adhesion to a tooth or have a mesh thin screen wire attached or otherwise laminated to the tooth-bonding-pad.

FIG. 4 is a distal or mesial view of a cross section block diagram of apparatus 300 according to an implementation illustrating an archwire exiting or protruding from a side of a tooth-bonding-pad.

In apparatus 300, the archwire 102 is permanently fabricated into the matter of a tooth-bonding-pad. The tooth-bonding-pad in apparatus 300 is any one of the tooth-bonding-pads 104-130 shown in FIG. 1 and FIG. 2. In the implementation shown in FIG. 4, the tooth-bonding-pad includes a bonding-pad thickness 402 in a range of 1.5 mm to 4 mm and a bonding-pad thickness 306 in a range of 0.10 mm to 2.0 mm. However, the disclosure herein is not limited to any particular dimensions of the tooth-bonding-pads or the archwire 102.

As shown in FIG. 4, most of the outside surface of the archwire 102 of apparatus 300 is fabricated into the tooth-bonding-pads 104-130. In the implementation shown in FIG. 4, about 75% (3 of 4 surfaces) of the outside surface of the archwire 102 of apparatus 300 is fabricated into the tooth-bonding-pads 104-130. The archwire 102 of apparatus 300 is fabricated into the side 301 of the tooth-bonding-pads 104-130.

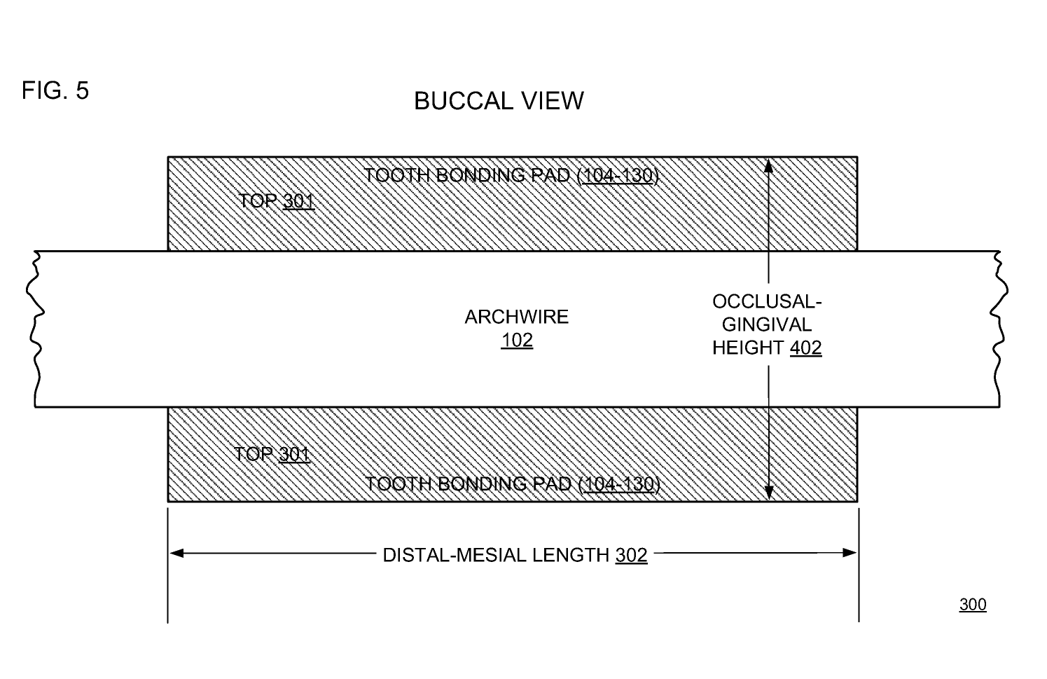

FIG. 5 is a buccal view of a cross section block diagram of apparatus 300 according to an implementation illustrating an archwire exiting or protruding from a side of a tooth-bonding-pad.

In apparatus 300, most of the outside surface of the archwire 102 is fabricated into the side 301 of the tooth-bonding-pads 104-130. In the implementation shown in FIG. 3 and FIG. 5, the tooth-bonding-pad 104-130 includes a mesial-distal length 302 in a range of 1.5 mm to 3.0 mm and a bonding-pad thickness 306 in a range of 0.10 mm to 2.0 mm.

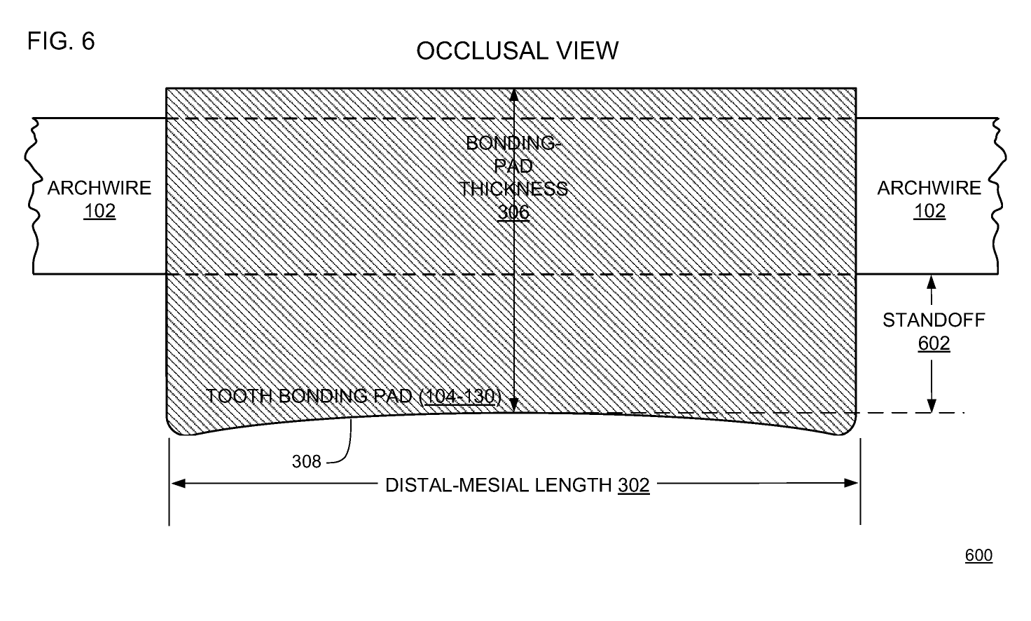

FIG. 6 is an occlusal view of a cross section block diagram of apparatus 600 according to an implementation illustrating an archwire exiting or protruding from an interior of a tooth-bonding-pad. Apparatus 600 is a unitary tooth-bonding-pad/archwire apparatus that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the apparatus 600 is applied, thus reducing friction of the inside of the cheek on the archwire 102, and thus improving comfort of the patient to which the apparatus 600 is applied.

In apparatus 600, the archwire 102 extends through the interior of the matter of the tooth-bonding-pad in FIG. 6. The tooth-bonding-pad in apparatus 600 in FIG. 6 is any one of the tooth-bonding-pads 104-130 shown in FIG. 1 and FIG. 2. In apparatus 600, the archwire 102 passes through the tooth-bonding-pad in FIG. 6. In the implementation shown in FIG. 6, the tooth-bonding-pad includes a mesial-distal length 302 in a range of 1.5 mm to 3.0 mm, a standoff 602 in the range of 0.125 mm to 0.140 mm and a tooth-bonding-pad thickness 306 in a range of 0.125 mm to 1.5 mm. In no case is the bonding-pad thickness 306 greater than the standoff 602 plus the diameter of the archwire 102. However, the disclosure herein is not limited to any particular dimensions of the mesial-distal length 302, standoff 602, tooth-bonding-pad thickness 306, tooth-bonding-pads 104-130 or the archwire 102. The standoff 602 shown in FIG. 6 is a medium dimension of the standoff 602. In some cases in which the dimension of standoff 602 is de minimus, the standoff 602 is approx 0.125 mm.

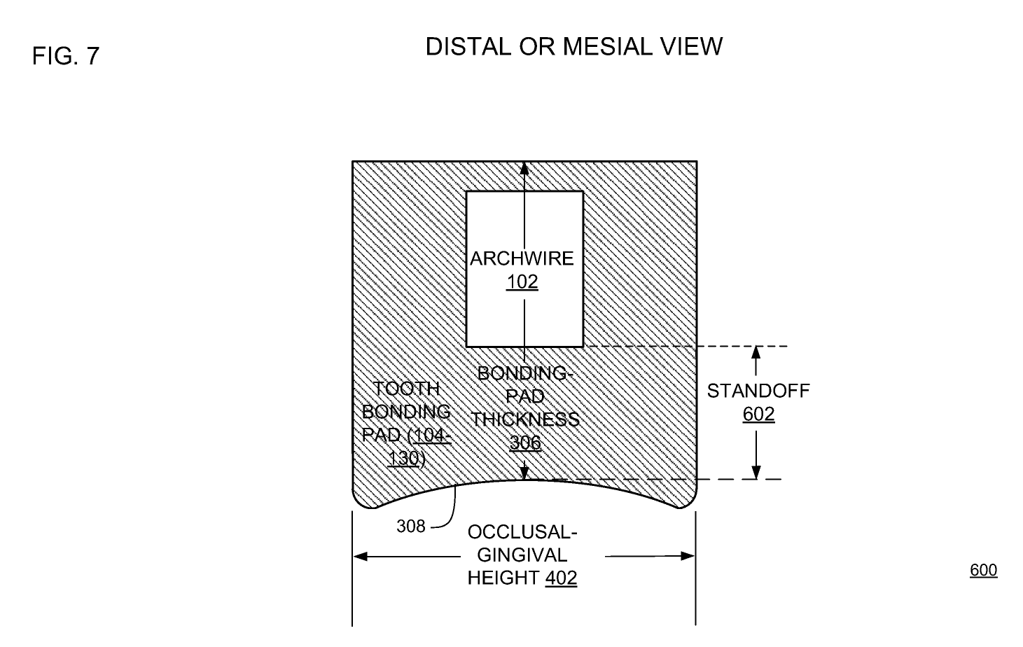

In some implementations of apparatus 600, most of the outside surface of the archwire 102 is fabricated into the tooth-bonding-pads 104-130, as described in greater detail in FIG. 7. In some implementations of apparatus 600, the archwire 102 is permanently fabricated into the interior of the matter of the tooth-bonding-pad.

The absence of an orthodontic bracket in apparatus 600 provides a lower profile and a smaller standoff 602. The smaller standoff 602 of apparatus 600 positions the archwire 102 closer to the gingival and thus further away from the inside of the cheek of the patient, thus reducing friction between the inside of the cheek and the archwire 102, and therefore improving comfort of the patient.

FIG. 7 is a distal or mesial view of a cross section block diagram of apparatus 600 according to an implementation illustrating an archwire exiting or protruding from an interior of a tooth-bonding-pad.

In apparatus 600, the archwire 102 is permanently fabricated into the matter of a tooth-bonding-pad. The tooth-bonding-pad in apparatus 600 is any one of the tooth-bonding-pads 104-130 shown in FIG. 1 and FIG. 2. In the implementation shown in FIG. 7, the tooth-bonding-pad includes a distal-mesial length 302 in a range of 1.5 mm to 3.0 mm and a tooth-bonding thickness 306 in a range of 0.10 mm to 2.0 mm. However, the disclosure herein is not limited to any particular dimensions of the tooth-bonding-pads or the archwire 102.

As shown in FIG. 7, most of the outside surface of the archwire 102 of apparatus 600 is fabricated into the tooth-bonding-pads 104-130. In the implementation shown in FIG. 7, about 100% (4 of 4 surfaces) of the outside surface in close proximity to the archwire 102 of apparatus 600 is fabricated into the tooth-bonding-pads 104-130. The archwire 102 of apparatus 600 is fabricated into the interior of the tooth-bonding-pads 104-130.

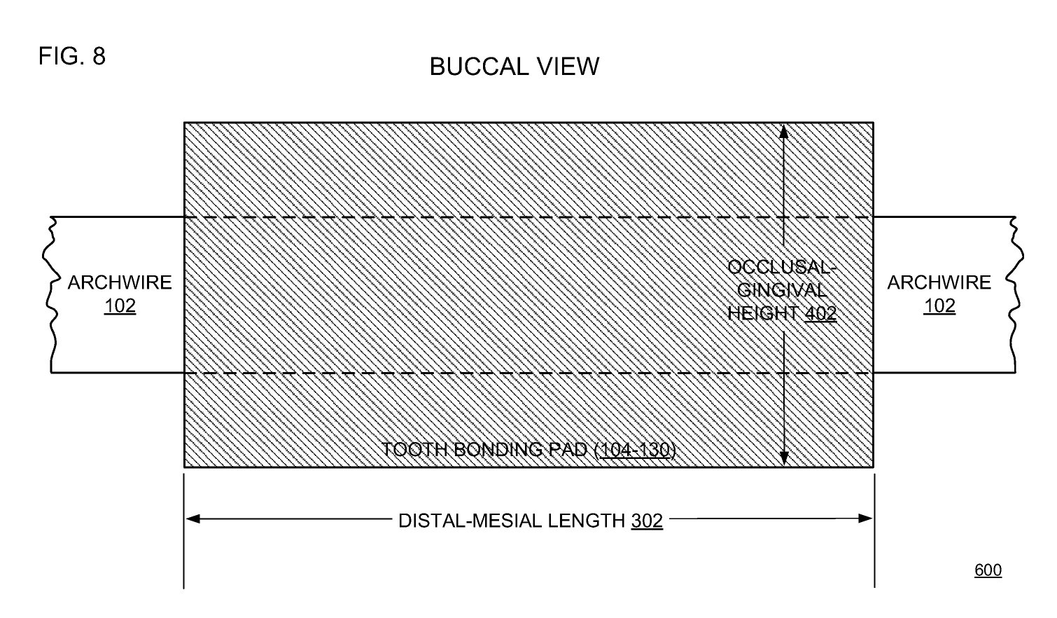

FIG. 8 is a buccal view of a cross section block diagram of apparatus 600 according to an implementation illustrating an archwire exiting or protruding from an interior of a tooth-bonding-pad.

In apparatus 600, most of the outside surface of the archwire 102 is fabricated into the interior of the tooth-bonding-pads 104-130. In the implementation shown in FIGS. 6 and 8, the tooth-bonding-pad 104-130 includes a mesial-distal length 302 in a range of 1.5 mm to 3.0 mm and a bonding-pad thickness 306 in a range of 0.10 mm to 2.0 mm.

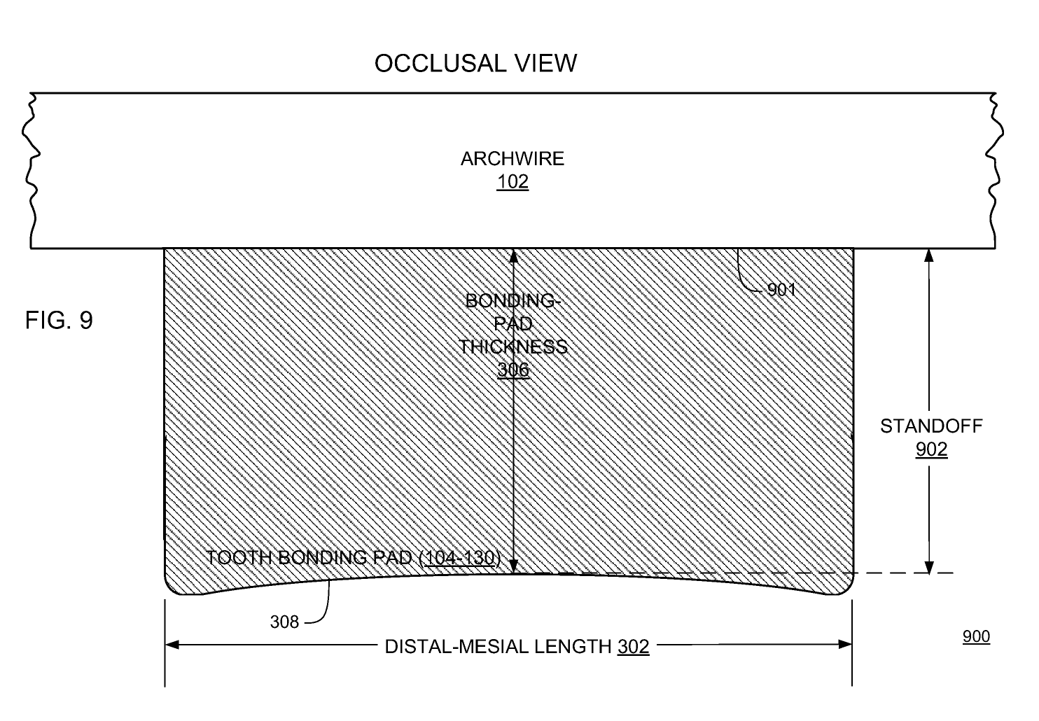

FIG. 9 is an occlusal view of a cross section block diagram of apparatus 900 according to an implementation illustrating an archwire removeably attached to a side of a tooth-bonding-pad. Apparatus 900 is a unitary tooth-bonding-pad/archwire apparatus that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the apparatus 900 is applied, thus reducing friction of the inside of the cheek on the archwire 102, and thus improving comfort of the patient to which the apparatus 900 is applied.

In apparatus 900, the archwire 102 is fabricated onto the side 901 of the tooth-bonding-pad. The tooth-bonding-pad in apparatus 900 is any one of the tooth-bonding-pads 104-130 shown in FIG. 1 and FIG. 2. In apparatus 900, less than half of the outside surface of the archwire 102 that is in close proximity to the tooth-bonding-pads 104-130 is fabricated onto the tooth-bonding-pads 104-130. In the implementation shown in FIG. 9, the tooth-bonding-pad includes a mesial-distal length 302 in a range of 1.5 mm to 3.0 mm, a standoff 902 in the range of 0.125 mm and 1.5 mm and a tooth-bonding-pad thickness 306 in a range of 0.1 mm to 2.0 mm. The bonding-pad thickness 306 is equal to the standoff 902. However, the disclosure herein is not limited to any particular dimensions of the mesial-distal length 302, standoff 902, tooth-bonding-pad thickness 306, tooth-bonding-pads 104-130 or the archwire 102.

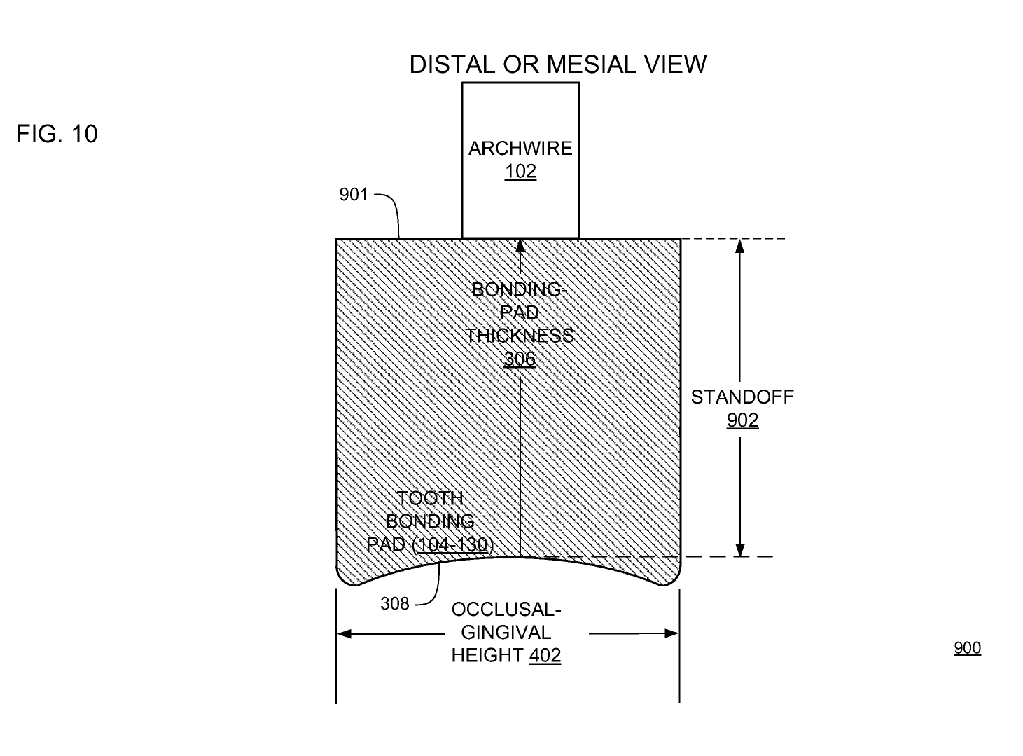

In apparatus 900, less than half of the outside surface of the archwire 102 is fabricated onto the tooth-bonding-pads 104-130, as described in greater detail in FIG. 10.

The absence of an orthodontic bracket in apparatus 900 provides a lower profile and a smaller occlusal-gingival height 402. The smaller occlusal-gingival height 402 of apparatus 900 positions the archwire 102 closer to the gingival and thus further away from the inside of the cheek of the patient, thus reducing friction between the inside of the cheek and the archwire 102, and therefore improving comfort of the patient.

FIG. 10 is a distal or mesial view of a cross section block diagram of apparatus 900 according to an implementation illustrating an archwire removeably attached to a side of a tooth-bonding-pad.

In apparatus 900, the archwire 102 is permanently fabricated onto the matter of a tooth-bonding-pad. The tooth-bonding-pad in apparatus 900 is any one of the tooth-bonding-pads 104-130 shown in FIG. 1 and FIG. 2. In the implementation shown in FIG. 10, the tooth-bonding-pad includes a bonding-pad thickness 306 in a range of 0.10 mm to 2.0 mm and a distal-mesial length 302 in a range of 1.5 mm to 3.0 mm. However, the disclosure herein is not limited to any particular dimensions of the tooth-bonding-pads or the archwire 102.

As shown in FIG. 10, less than half of the outside surface of the archwire 102 of apparatus 900 is fabricated onto the tooth-bonding-pads 104-130. In the implementation shown in FIG. 10, about 25% (1 of 4 surfaces) of the outside surface of the archwire 102 of apparatus 900 is fabricated onto the tooth-bonding-pads 104-130. The archwire 102 of apparatus 900 is fabricated onto the side 901 of the tooth-bonding-pads 104-130.

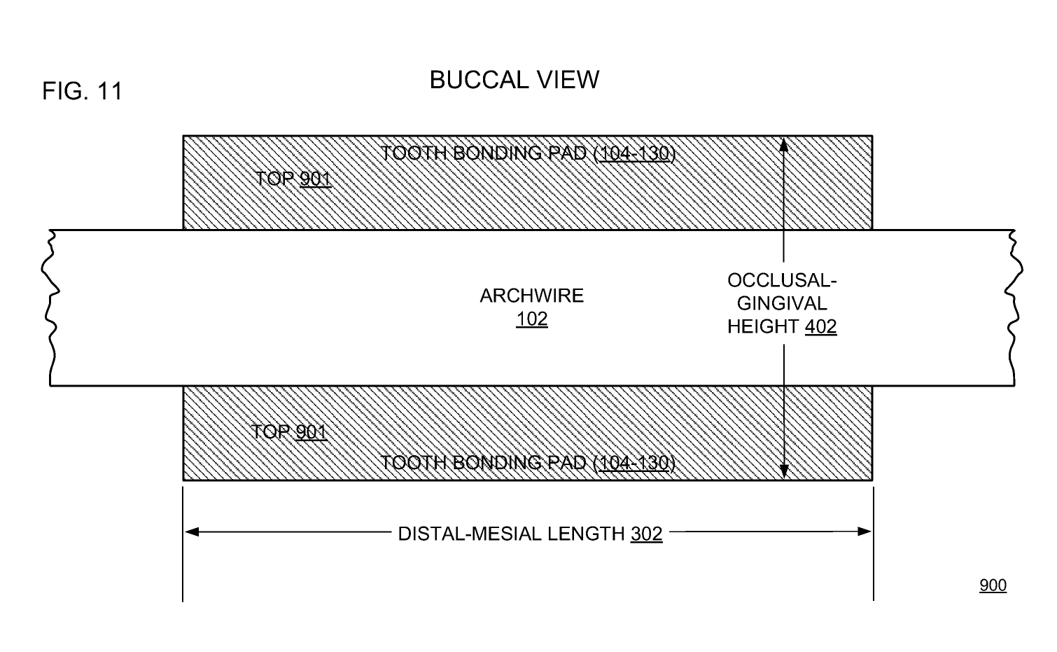

FIG. 11 is a buccal view of a cross section block diagram of apparatus 900 according to an implementation illustrating an archwire removeably attached to a side of a tooth-bonding-pad.

In apparatus 900, less than half of the outside surface of the archwire 102 is fabricated onto the side 901 of the tooth-bonding-pads 104-130. In the implementation shown in FIGS. 9 and 11, the tooth-bonding-pad 104-130 includes a mesial-distal length 302 in a range of 1.5 mm to 3.0 mm and an occlusal-gingival height 402 in a range of 1.5 mm to 4 mm.

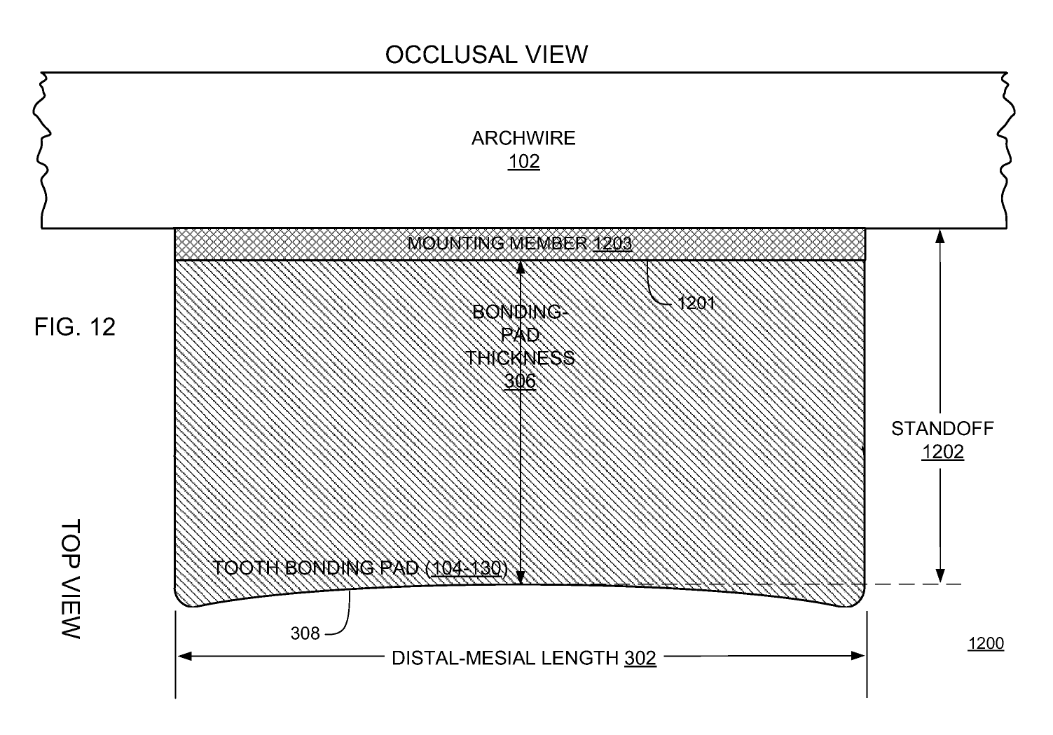

FIG. 12 is an occlusal view of a cross section block diagram of apparatus 1200 according to an implementation illustrating an archwire indirectly attached to a side of a tooth-bonding-pad. Apparatus 1200 is a unitary tooth-bonding-pad/archwire apparatus that does not have or include an orthodontic bracket, which as a result of the absent orthodontic bracket, can be attached easily, simply and inexpensively, and that has a low physical profile and a smaller height dimension that positions the archwire 102 further away from the inside of the cheek of a patient to which the apparatus 1200 is applied, thus reducing friction of the inside of the cheek on the archwire 102, and thus improving comfort of the patient to which the apparatus 1200 is applied.

In apparatus 1200, the archwire 102 is indirectly attached onto the side 1201 of the tooth-bonding-pad though a mounting member 1203. The tooth-bonding-pad in apparatus 1200 is any one of the tooth-bonding-pads 104-130 shown in FIG. 1 and FIG. 2. In apparatus 1200, none of the outside surface of the archwire 102 that is in close proximity to the tooth-bonding-pads 104-130 is directly attached to the tooth-bonding-pads 104-130 though the mounting member 1203. In the implementation shown in FIG. 12, the tooth-bonding-pad includes a mesial-distal length 302 in a range of 1.5 mm to 3.0 mm, a standoff 1202 in the range of 0.25 mm and 1.75 mm and an occlusal-gingival height 402 in a range of 1.5 mm to 4 mm. However, the disclosure herein is not limited to any particular dimensions of the mesial-distal length 302, standoff 1202, occlusal-gingival height 402, tooth-bonding-pads 104-130 or the archwire 102.

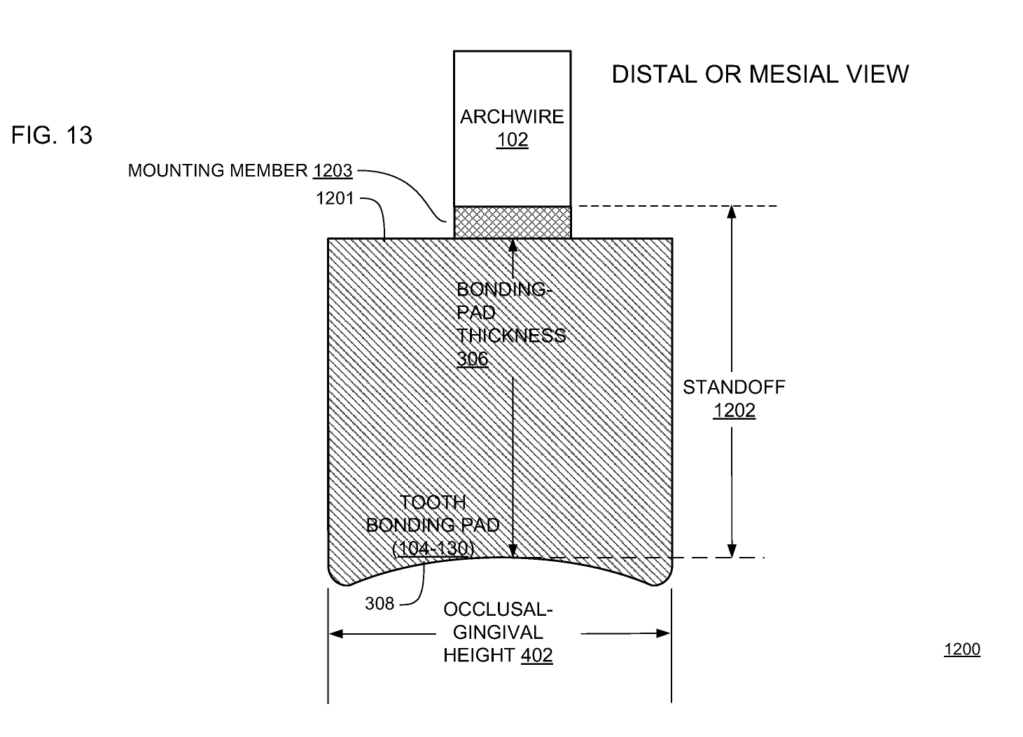

In apparatus 1200, none of the outside surface of the archwire 102 is directly attached to the tooth-bonding-pads 104-130 though the mounting member 1203, as described in greater detail in FIG. 13.

The absence of an orthodontic bracket in apparatus 1200 provides a lower profile and a smaller occlusal-gingival height 402. The smaller occlusal-gingival height 402 of apparatus 1200 positions the archwire 102 closer to the gingival and thus further away from the inside of the cheek of the patient, thus reducing friction between the inside of the cheek and the archwire 102, and therefore improving comfort of the patient.

FIG. 13 is a distal or mesial view of a cross section block diagram of apparatus 1200 according to an implementation illustrating an archwire removeably attached to a side of a tooth-bonding-pad.

In apparatus 1200, the archwire 102 is permanently attached to the matter of a tooth-bonding-pad through a mounting member 1203. The tooth-bonding-pad in apparatus 1200 is any one of the tooth-bonding-pads 104-130 shown in FIG. 1 and FIG. 2. In the implementation shown in FIG. 13, the tooth-bonding-pad includes a bonding-pad thickness 306 in a range of 0.10 mm to 2.0 mm and a distal-mesial length 302 in a range of 1.5 mm to 3.0 mm. However, the disclosure herein is not limited to any particular dimensions of the tooth-bonding-pads or the archwire 102.

As shown in FIG. 13, none of the outside surface of the archwire 102 of apparatus 1200 is attached directly onto the tooth-bonding-pads 104-130. In the implementation shown in FIG. 13, 0% (0 of 4 surfaces) of the outside surface of the archwire 102 of apparatus 1200 is directly attached to the tooth-bonding-pads 104-130. Instead, the archwire 102 of apparatus 1200 is attached to the side 1201 of the tooth-bonding-pads 104-130 through the mounting member 1203.

FIGS. 3, 4, 6, 7, 9, 10, 12 and 13 show a curved surface onto which the tooth-bonding-pad adheres to the curved surface of the tooth. The geometry of the curved surface in FIGS. 3, 4, 6, 7, 9, 10, 12 and 13 is merely illustrative, and not necessarily exemplary and not limiting because curved surfaces of other geometries are within contemplation to accommodate tooth surface curvature geometries of a large variety.

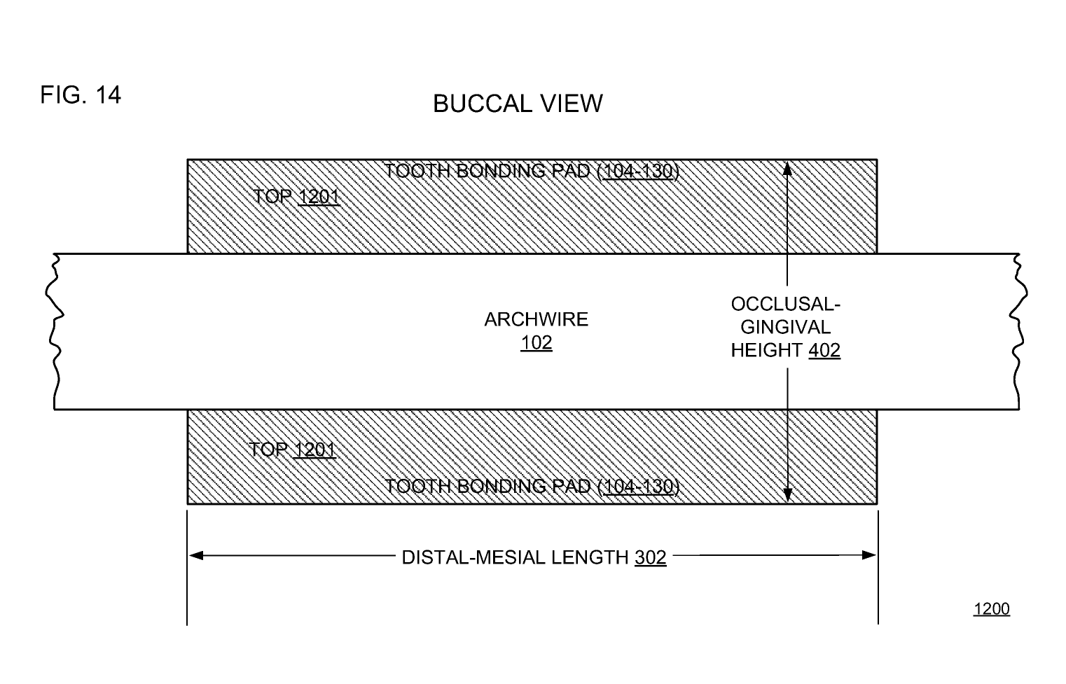

FIG. 14 is a buccal view of a cross section block diagram of apparatus 1200 according to an implementation illustrating an archwire removeably attached to a side of a tooth-bonding-pad.

In apparatus 1200, none of the outside surface of the archwire 102 is attached directly to the side 1201 of the tooth-bonding-pads 104-130. In the implementation shown in FIGS. 12 and 14, the tooth-bonding-pad 104-130 includes a mesial-distal length 302 in a range of 1.5 mm to 3.0 mm and a bonding-pad thickness 402 in a range of 1.5 mm to 4 mm.

The archwire 102 is depicted in FIGS. 4, 7, 10 and 13 as being rectangular in cross-section. However, the geometry of the archwire can be any variety of geometries in cross-section, such as round, oval, eliptical, square, pentagular, heptangular, octangular, decangular, or asymmetrical.

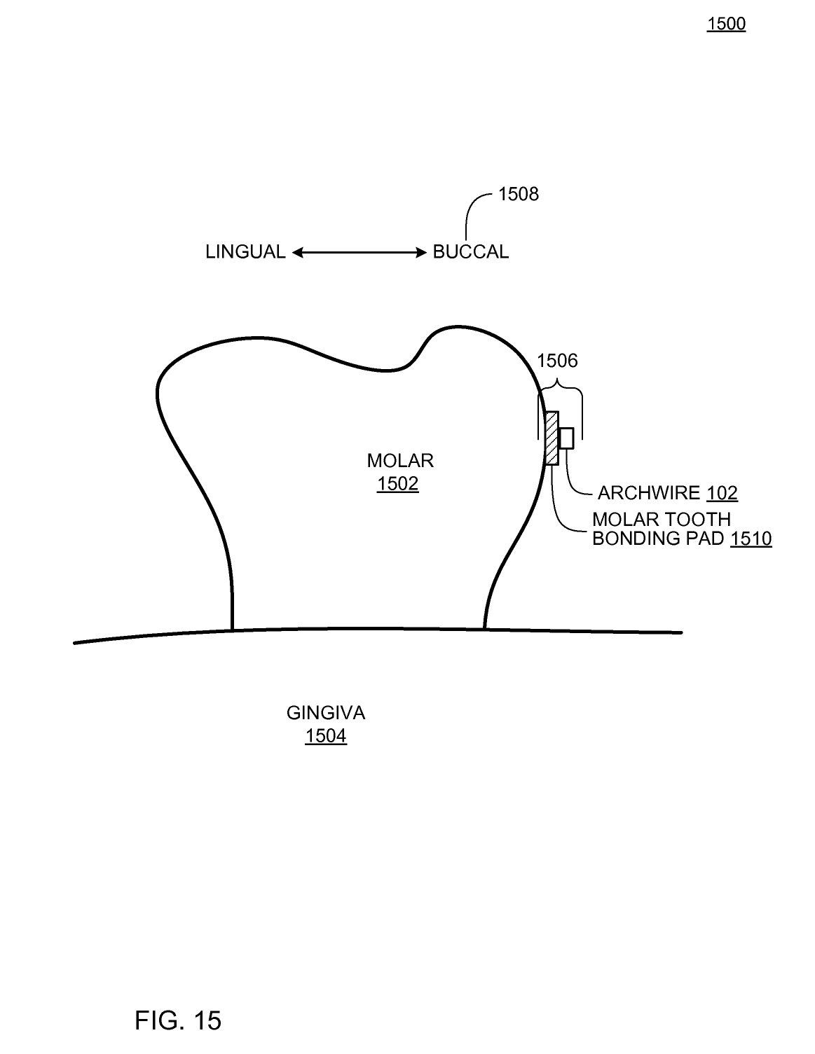

FIG. 15 is a block diagram 1500 of a molar unitary tooth-bonding-pad/archwire apparatus applied to a molar tooth, according to an implementation. FIG. 15 shows a molar tooth 1502 situated in gingival tissue 1504. A molar unitary tooth-bonding-pad/archwire apparatus 1506 that is applied to the buccal surface 1508 of the molar tooth 1502. The molar unitary tooth-bonding-pad/archwire apparatus 1506 includes a molar tooth bonding pad 1510 that is removeably attached to the buccal surface 1508 of the molar tooth 1502. An archwire 102 of the molar unitary tooth-bonding-pad/archwire apparatus 1506 is attached to the molar tooth bonding pad 1510.

Apparatus 100, apparatus 200, apparatus 300, apparatus 600, apparatus 900 and apparatus 1200 are implementations of the molar unitary tooth-bonding-pad/archwire apparatus 1506. The molar unitary tooth-bonding-pad/archwire apparatus 1506 does not have or include an orthodontic bracket, which as a result of the absent orthodontic bracket, the molar unitary tooth-bonding-pad/archwire apparatus 1506 can be fabricated easily, simply and inexpensively, and the molar unitary tooth-bonding-pad/archwire apparatus 1506 has a low physical profile and a smaller height dimension that positions the archwire 102 further away from the inside of the cheek of the patient, thus reducing friction of the inside of the cheek on the archwire 102, and thus improving comfort of the patient.

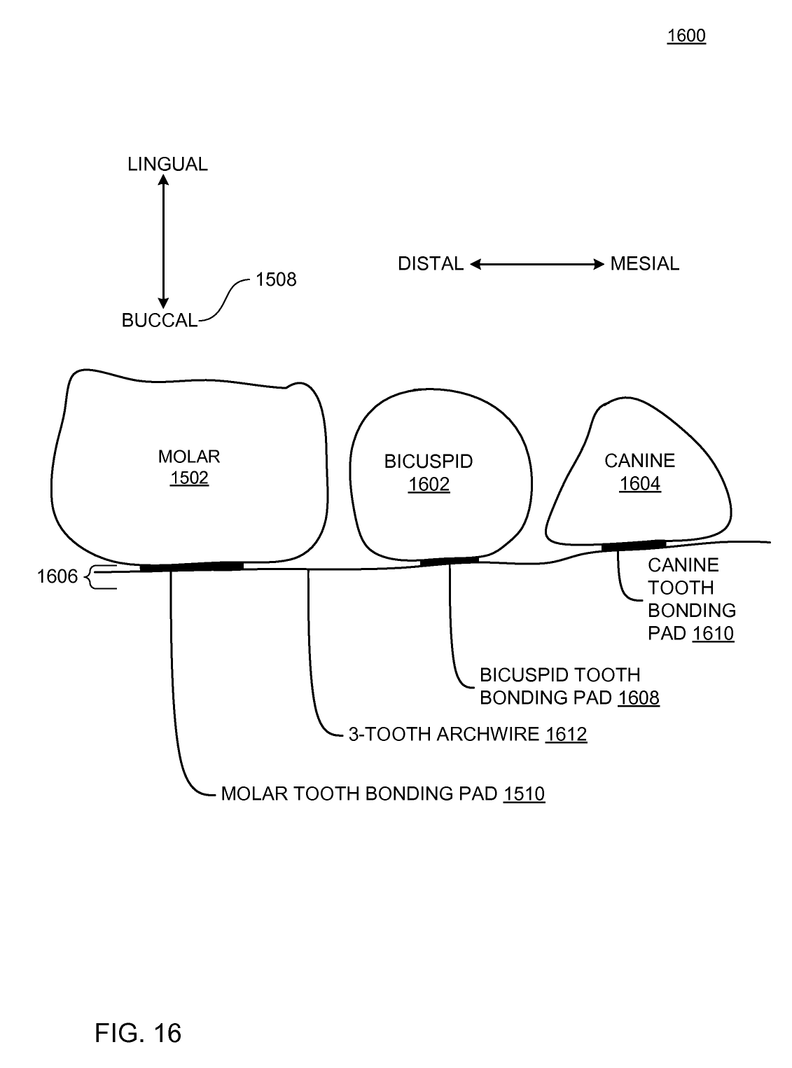

FIG. 16 is an occlusal-view block diagram of a unitary tooth-bonding-pad/archwire apparatus 1600 applied to a molar tooth, a bicuspid tooth and a canine tooth, according to an implementation. FIG. 16 shows a molar tooth 1502, a bicuspid tooth 1602 and a canine tooth 1604. A unitary tooth-bonding-pad/archwire apparatus 1606 includes a molar tooth bonding pad 1510 that is removeably attached to the buccal surface 1508 of the molar tooth 1502. The unitary tooth-bonding-pad/archwire apparatus 1606 includes a bicuspid tooth bonding pad 1608 that is removeably attached to the buccal surface 1508 of the bicuspid tooth 1602. The unitary tooth-bonding-pad/archwire apparatus 1606 includes a canine tooth bonding pad 1610 that is removeably attached to the buccal surface 1508 of the canine tooth 1604.

A three-tooth segment of archwire 1612 of the unitary tooth-bonding-pad/archwire apparatus 1606 is attached to the molar tooth bonding pad 1510, the bicuspid tooth bonding pad 1608 and the canine tooth bonding pad 1610.

Apparatus 100, apparatus 200, apparatus 300, apparatus 600, apparatus 900 and apparatus 1200 are implementations of the unitary tooth-bonding-pad/archwire apparatus 1606. The unitary tooth-bonding-pad/archwire apparatus 1606 does not have or include an orthodontic bracket, which as a result of the absent orthodontic bracket the unitary tooth-bonding-pad/archwire apparatus 1606 can be fabricated easily, simply and inexpensively, and the unitary tooth-bonding-pad/archwire apparatus 1606 has a low physical profile and a smaller height dimension that positions the archwire further away from the inside of the cheek of the patient, thus reducing friction of the inside of the cheek on the archwire, and thus improving comfort of the patient.

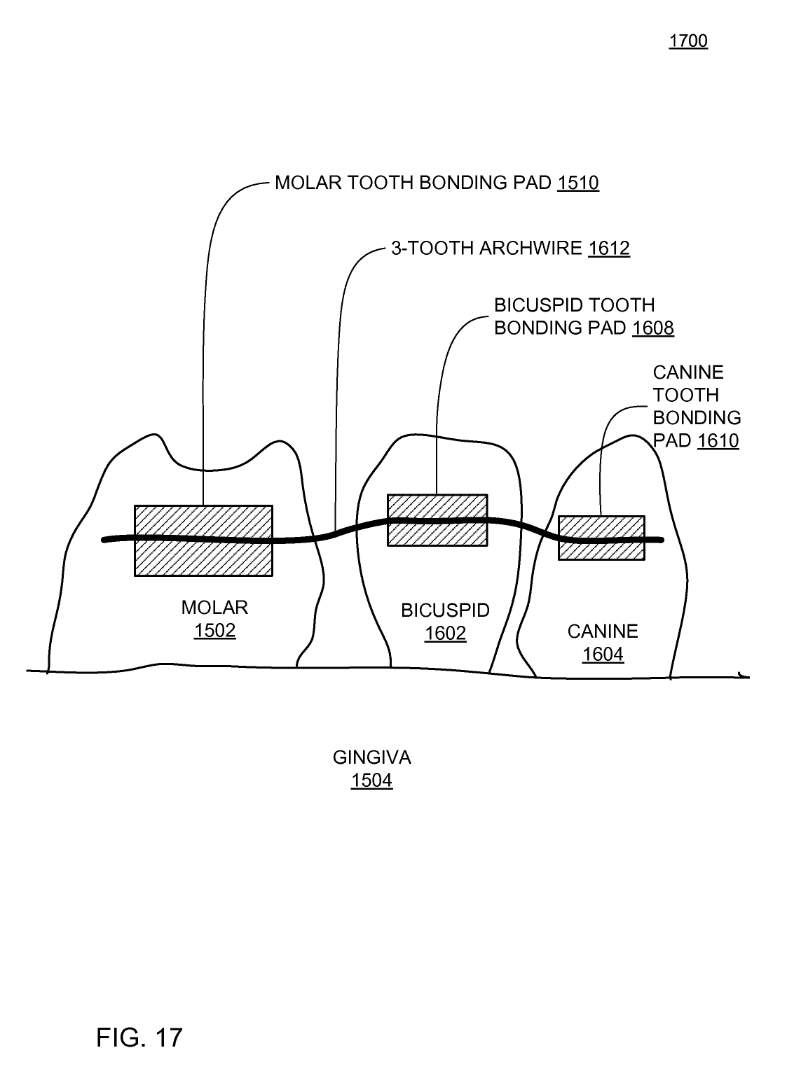

FIG. 17 is a buccal-view block diagram 1700 of a unitary tooth-bonding-pad/archwire apparatus applied to a molar tooth, a bicuspid tooth and a canine tooth, according to an implementation. FIG. 17 shows a molar tooth 1502, a bicuspid tooth 1602 and a canine tooth 1604 situated in gingival tissue 1504. A unitary tooth-bonding-pad/archwire apparatus 1606 includes a molar tooth bonding pad 1510 that is removeably attached to the buccal surface 1508 of the molar tooth 1502. The unitary tooth-bonding-pad/archwire apparatus 1606 includes a bicuspid tooth bonding pad 1608 that is removeably attached to the buccal surface 1508 of the bicuspid tooth 1602. The unitary tooth-bonding-pad/archwire apparatus 1606 includes a canine tooth bonding pad 1610 that is removeably attached to the buccal surface 1508 of the canine tooth 1604.

A three-tooth segment of archwire 1612 of the unitary tooth-bonding-pad/archwire apparatus 1606 is attached to the molar tooth bonding pad 1510, the bicuspid tooth bonding pad 1608 and the canine tooth bonding pad 1610.

Apparatus 100, apparatus 200, apparatus 300, apparatus 600, apparatus 900 and apparatus 1200 are implementations of the unitary tooth-bonding-pad/archwire apparatus 1606. The unitary tooth-bonding-pad/archwire apparatus 1606 does not have or include an orthodontic bracket, which as a result of the absent orthodontic bracket, the unitary tooth-bonding-pad/archwire apparatus 1606 can be fabricated easily, simply and inexpensively, and the unitary tooth-bonding-pad/archwire apparatus 1606 has a low physical profile and a smaller height dimension that positions the archwire further away from the inside of the cheek of a patient to which the unitary tooth-bonding-pad/archwire apparatus 1606 is applied, thus reducing friction of the inside of the cheek on the archwire 1606, and thus improving comfort of the patient to which the unitary tooth-bonding-pad/archwire apparatus 1606 is applied.

The dimensions and sizes of apparatus shown in FIG. 1, FIG. 2, FIG. 4, FIG. 15, FIG. 16 and FIG. 17 are not exemplary or limiting.

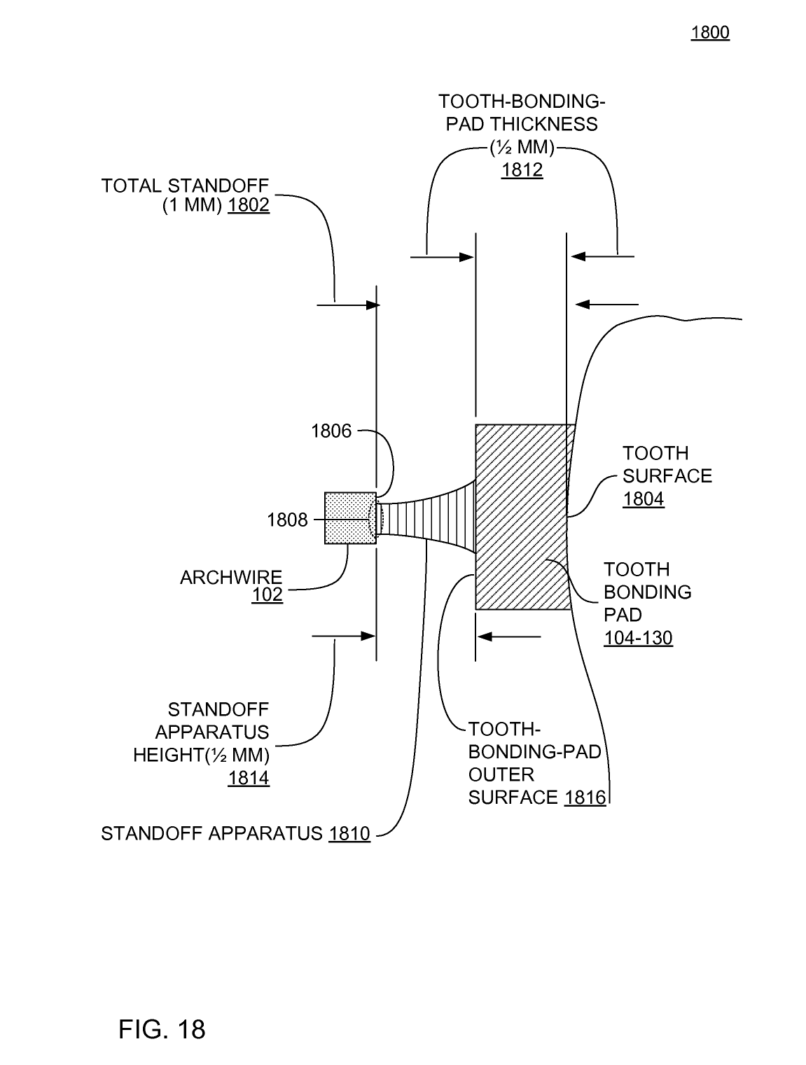

FIG. 18 is a side-view block diagram of a unitary tooth-bonding-pad/archwire apparatus 1800, according to an implementation having a short stand-off apparatus. A total standoff 1802 of a unitary tooth-bonding-pad/archwire apparatus is the distance between the surface of the tooth 1804 and the inner surface 1806 of the archwire 102 at the attachment area 1808 between the archwire and a standoff apparatus 1810. In the implementation shown in FIG. 18, the total standoff 1802 distance is 1 mm. The total standoff 1802 comprises two components: (1) the thickness 1812 of the bonding pad 104-130 and (2) the distance 1814 between the outer surface 1816 of the tooth-bonding-pad 104-130 and where the archwire 102 is attached to the inner surface 1806 of the attachment area 1808. The total standoff 1802 is simply the sum of (1) and (2) above. In the implementation shown in FIG. 18, the total standoff 1802 of 1 mm is the sum of the ½ mm thickness 1812 of the bonding pad 104-130 and the ½ mm distance 1814 between the outer surface 1816 of the bonding pad 104-130 where the archwire 102 is attached to the inner surface 1806 of the attachment area 1808.

The distance 1814 is also known as the “bonding pad offset”. In some applications of the unitary tooth-bonding-pad/apparatus, the desired result benefits from, or be enhanced by the bonding pad offset 1814 created by the standoff apparatus 1810. The applications which benefit from the bonding pad offset 1814 created by the standoff apparatus 1810 include treatment of relapse of previous orthodontic treatment, which in some instances have no bonding pad offset 1814 (0 mm) and no standoff apparatus 1810 at the canines and molars, and between ½ mm and 2 mm of offset at the incisors and bicuspids. For this application, the larger values of bonding pad offset 1814 can be associated with the lower incisors, the mid range values of offset with the upper incisors, and the smaller values with the bicuspids. Particular formulations or prescriptions for offset values should not be considered as limiting the claims nor the scope of this disclosure.

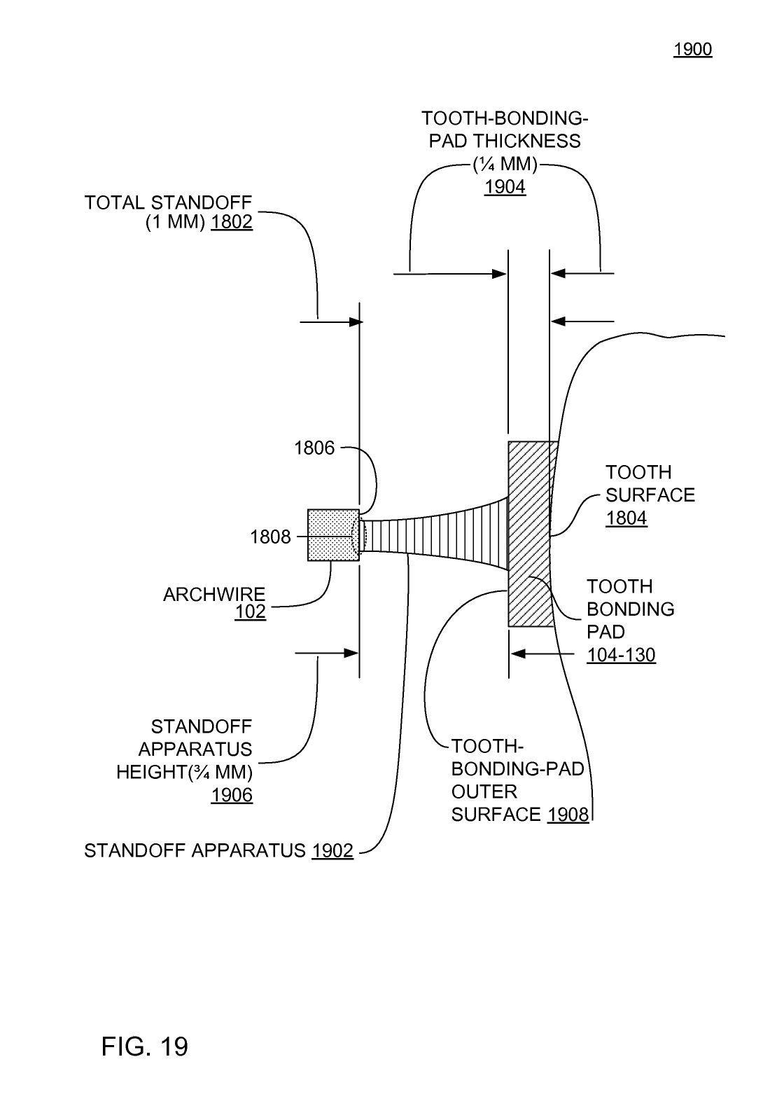

FIG. 19 is a side-view block diagram of a unitary tooth-bonding-pad/archwire apparatus 1900, according to an implementation having a long standoff apparatus. A total standoff 1802 of a unitary tooth-bonding-pad/archwire apparatus is the distance between the surface of the tooth 1804 and the inner surface 1806 of the archwire 102 at the attachment area 1808 between the archwire and a standoff apparatus 1902. In the implementation shown in FIG. 18, the total standoff 1802 distance is 1 mm. The total standoff 1802 comprises two components: (1) the thickness 1904 of the bonding pad 104-130 and (2) the distance 1906 between the outer surface 1908 of the tooth-bonding-pad 104-130 and where the archwire 102 is attached to the inner surface 1806 of the attachment area 1808. The total standoff 1802 is simply the sum of (1) and (2) above. In the implementation shown in FIG. 19, the total standoff 1802 of 1 mm is the sum of the ¼ mm thickness 1904 of the bonding pad 104-130 and the ¾ mm distance 1906 between the outer surface 1908 of the bonding pad 104-130 where the archwire 102 is attached to the inner surface 1806 of the attachment area 1808.

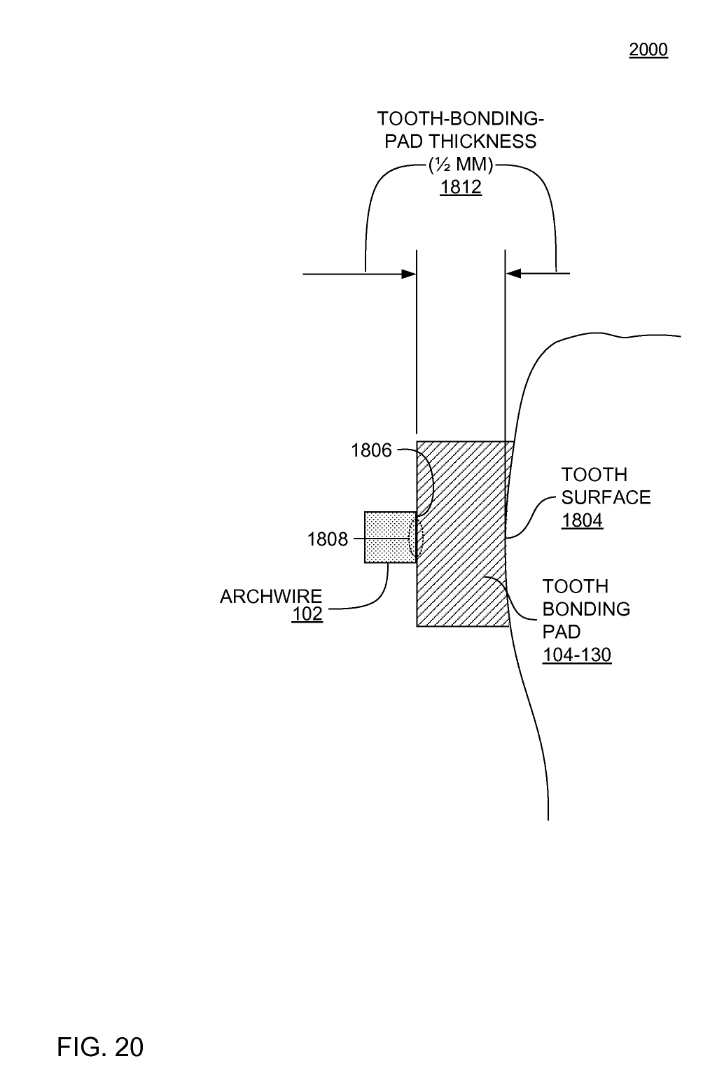

FIG. 20 is a side-view block diagram of a unitary tooth-bonding-pad/archwire apparatus 2000, according to an implementation having no standoff apparatus. A total standoff of the unitary tooth-bonding-pad/archwire apparatus is the distance between the surface of the tooth 1804 and the inner surface 1806 of the archwire 102 at the attachment area 1808 between the archwire 102 and the surface of the tooth 1804. In the implementation shown in FIG. 20, the total standoff distance is ½ mm. The total standoff comprises one component: (1) the thickness 1812 of the bonding pad 104-130.

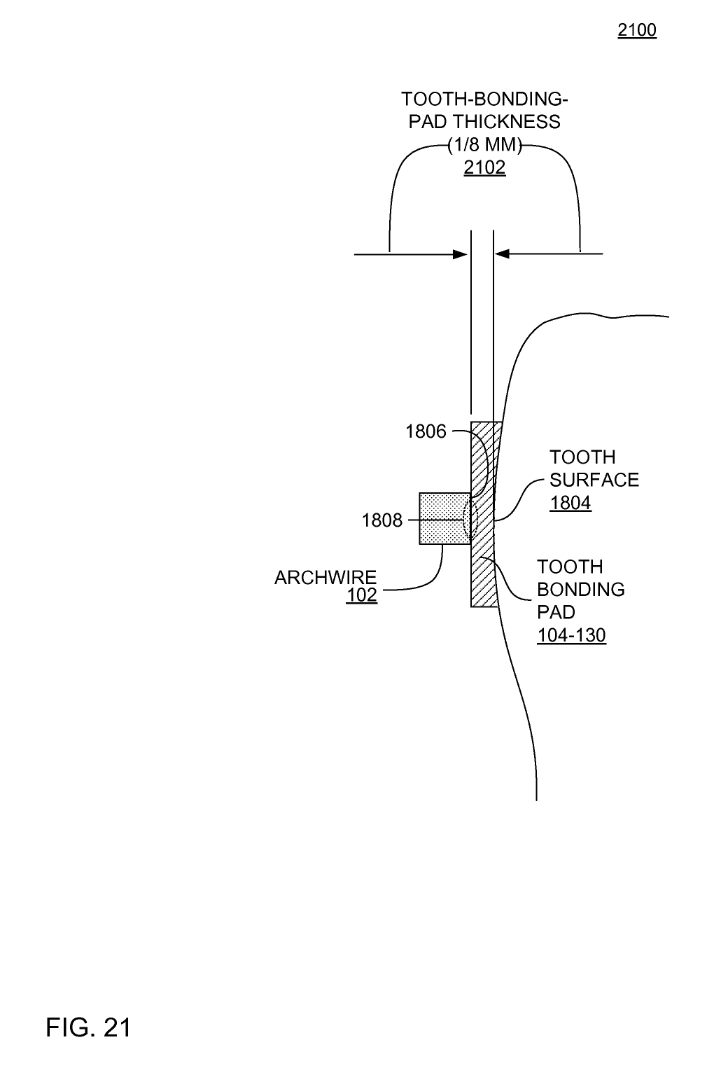

FIG. 21 is a side-view block diagram of a unitary tooth-bonding-pad/archwire apparatus 2100, according to an implementation having no standoff apparatus. A total standoff of the unitary tooth-bonding-pad/archwire apparatus is the distance between the surface of the tooth 1804 and the inner surface 1806 of the archwire 102 at the attachment area 1808 between the archwire 102 and the surface of the tooth 1804. In the implementation shown in FIG. 21, the total standoff distance is ½ mm. The total standoff comprises one component: (1) the thickness 2102 of the bonding pad 104-130.

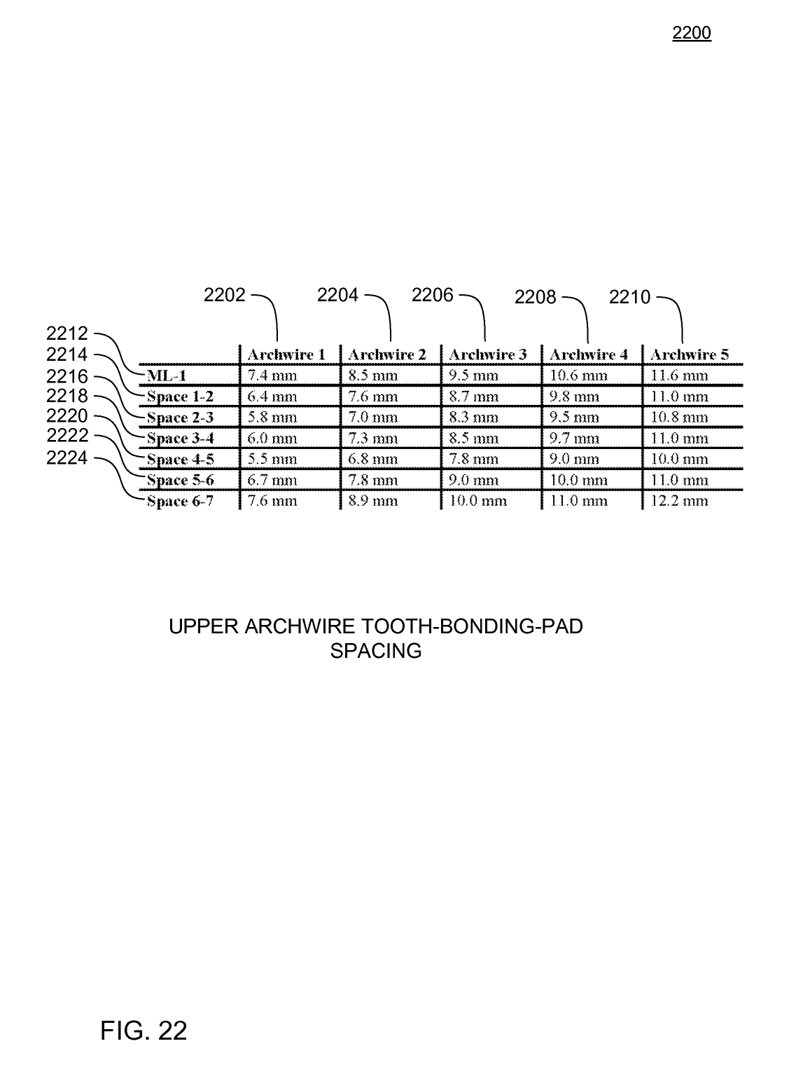

FIG. 22 is a buccal side-view block diagram of a unitary tooth-bonding-pad/archwire apparatus having a tubular holder 2200 of the archwire applied to a bicuspid tooth, according to an implementation.

FIG. 22 shows a bicuspid tooth 1602 situated in gingival tissue 1504. The unitary tooth-bonding-pad/archwire apparatus 2200 includes a bicuspid tooth bonding pad 2202 that is removeably attached to the buccal surface 1508 of the bicuspid tooth 1602. The unitary tooth-bonding-pad/archwire apparatus 2202 also includes a tubular holder 2204 of the archwire 102.

The unitary tooth-bonding-pad/archwire apparatus 2200 does not have or include an orthodontic bracket, which as a result of the absent orthodontic bracket, the unitary tooth-bonding-pad/archwire apparatus 2200 can be fabricated easily, simply and inexpensively, and the unitary tooth-bonding-pad/archwire apparatus 2200 has a low physical profile and a smaller height dimension that positions the archwire further away from the inside of the cheek of a patient to which the unitary tooth-bonding-pad/archwire apparatus 2200 is applied, thus reducing friction of the inside of the cheek on the archwire 2200, and thus improving comfort of the patient to which the unitary tooth-bonding-pad/archwire apparatus 2200 is applied.

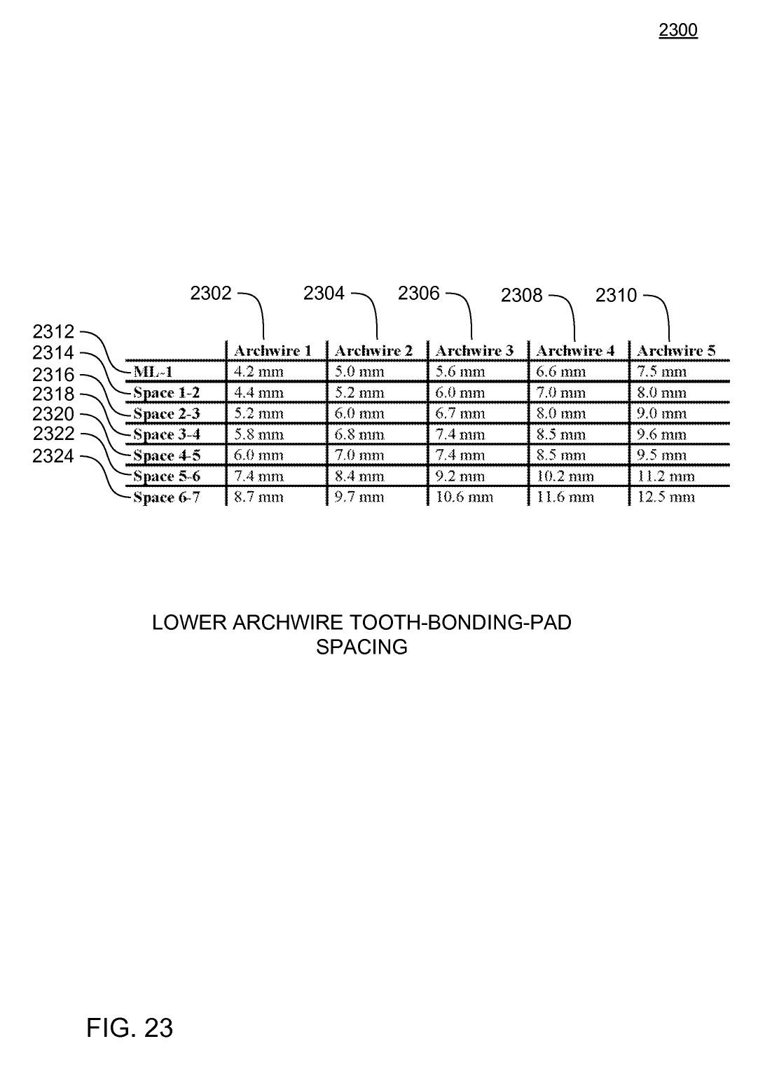

FIG. 23 is an occlusal-view block diagram of a unitary tooth-bonding-pad/archwire apparatus 2200 having a tubular holder of the archwire applied to a bicuspid tooth, according to an implementation.

FIG. 23 shows a bicuspid tooth 1602. The unitary tooth-bonding-pad/archwire apparatus 2200 includes a bicuspid tooth bonding pad 2202 that is removeably attached to the buccal surface 1508 of the bicuspid tooth 1602. The unitary tooth-bonding-pad/archwire apparatus 2200 also includes a tubular holder 2204 of the archwire 102.

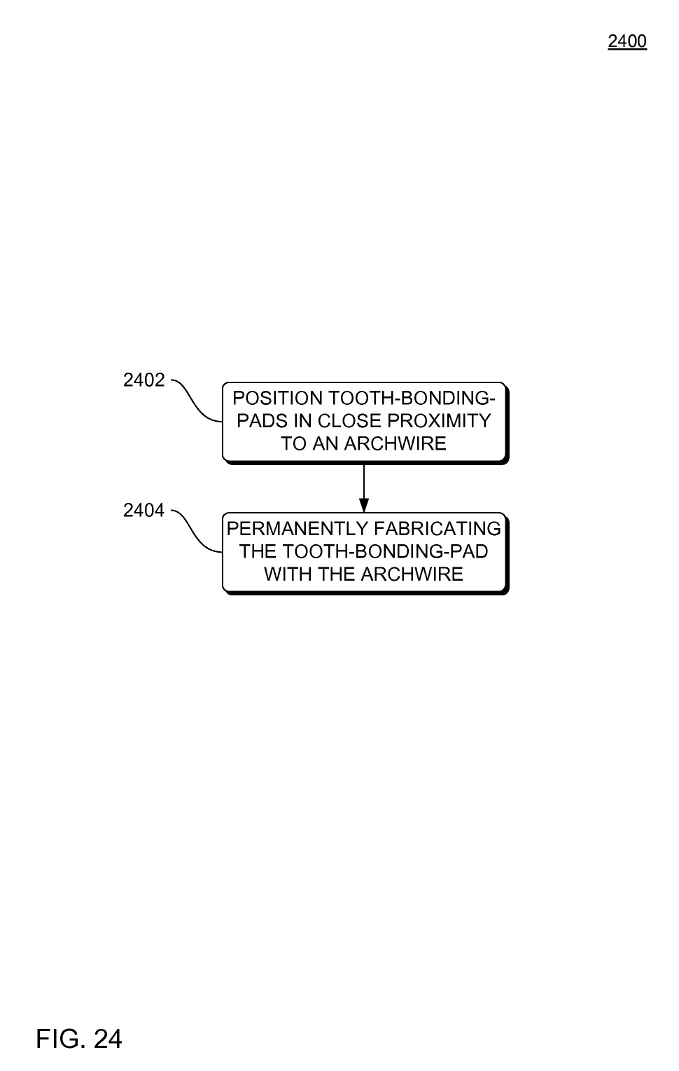

FIG. 24 is a mesial view block diagram of a unitary tooth-bonding-pad/archwire apparatus 2200 having a tubular holder of the archwire applied to a bicuspid tooth, according to an implementation.

FIG. 24 shows a bicuspid tooth 1602. The unitary tooth-bonding-pad/archwire apparatus 2200 includes a bicuspid tooth bonding pad 2202 that is removeably attached to the buccal surface 1508 of the bicuspid tooth 1602. The unitary tooth-bonding-pad/archwire apparatus 2200 also includes a tubular holder 2204 of the archwire 102.

The dimensions and sizes of apparatus shown in FIG. 22, FIG. 23 and FIG. 24 are not exemplary or limiting.

The geometries, shapes and dimensions of apparatus in FIGS. 1-24 are merely illustrative, and not necessarily exemplary and not limiting because other geometries, shapes and dimensions are within contemplation to accommodate tooth surfaces, sizes, geometries, shapes and dimensions of a large variety.

FIG. 22 is a table 2200 of spacing between tooth-bonding-pads in an upper archwire for a human, according to an implementation. An upper archwire is an archwire that is applied to the upper teeth in a human mouth. The spacing dimensions are between the centers of the tooth-bonding-pads, such as shown in FIG. 2. Table 2200 illustrates the spacing dimensions between the centers of tooth-bonding-pads of a number of different upper archwires, Archwire #1 (2002), Archwire #2 (2004), Archwire #3 (2006), Archwire #4 (2008) and Archwire #5 (2010). Table 2200 illustrates the spacing dimensions of the five different upper archwires (2002-2010) between the centers of tooth-bonding-pads for spaces “ML-1” 2212, “Space 1-2” 2214, “Space 2-3” 2216, “Space 3-4” 2218, “Space 4-5” 2220 “Space 5-6” 2222 and “Space 6-7” 2224. Table 2200 discloses that the spacing “Space 5-6” (208 and 232 in FIG. 2) between the centers of tooth-bonding-pads 106 and 108, and tooth-bonding-pads 126 and 128, respectively, for Archwire #2 is 7.8 mm.

FIG. 23 is a table 2300 of spacing between tooth-bonding-pads in a lower archwire for a human, according to an implementation. A lower archwire is an archwire that is applied to the lower teeth in a human mouth. The spacing dimensions are between the centers of the tooth-bonding-pads, such as shown in FIG. 2. Table 2300 illustrates the spacing dimensions between the centers of tooth-bonding-pads of a number of different lower archwires, Archwire #1 (2102), Archwire #2 (2104), Archwire #3 (2106), Archwire #4 (2108) and Archwire #5 (2110). Table 2300 illustrates the spacing dimensions of the five different lower archwires (2102-2110) between the centers of tooth-bonding-pads for spaces “ML-1” 2312, “Space 1-2” 2314, “Space 2-3” 2316, “Space 3-4” 2318, “Space 4-5” 2320 “Space 5-6” 2322 and “Space 6-7” 2324. Table 2300 discloses that the spacing “Space 1-2” (216 and 224 in FIG. 2) between the centers of tooth-bonding-pads 114 and 116, and tooth-bonding-pads 118 and 120, respectively, for Archwire #1 is 4.4 mm.

### Method Implementations

In the previous section, implementations of apparatus are described. In this section, particular methods of such those implementations are described by reference to a series of flowcharts.

FIG. 24 is a flowchart of a method 2400 to fabricate a unitary tooth-bonding-pad/archwire apparatus, according to an implementation. In method 2400, at least one tooth-bonding-pad and an archwire are transformed into a unitary tooth-bonding-pad/archwire apparatus, such as apparatus 100, apparatus 200, apparatus 300, apparatus 600, apparatus 900 and apparatus 1200.

Method 2400 includes positioning one or more tooth-bonding-pads in close proximity to an archwire at fixed positions of the archwire, at block 2402. One example of the tooth-bonding-pads are tooth-bonding-pads 104-130 in FIG. 1. One example of the archwire is archwire 102 in FIG. 1.

Method 2400 includes permanently fabricating the one or more tooth-bonding-pads with the archwire at fixed positions of the archwire, at block 2404.

In one implementation of permanently fabricating 2404 one or more tooth-bonding-pads with the archwire at fixed positions of the archwire, each of the plurality of tooth-bonding-pads is metallurgically permanently fabricated into the archwire at fixed positions of the archwire.

In one implementation of permanently fabricating one or more tooth-bonding-pads with an archwire at fixed positions of the archwire 2404, each of the plurality of tooth-bonding-pads (e.g. 104-130 in FIG. 1) are formed as one complete integral unit with the archwire (e.g. 102 in FIG. 1). Forming the tooth-bonding-pads as one complete integral unit with the archwire is performed in one implementation by casting or vacuum casting a melted metal into molds of magnesia and silica by a dental argon-arc pressure casting machine with a copper crucible, or by an argon arc centrifugal casting machine, or by an arc-melting gas pressure casting machine. One example of a dental argon-arc pressure casting machine is the AX-AWM1 dental argon-arc pressure casting machine manufactured by Tianjin Aixin Medical Equipment Co., Ltd in Tainjin, China 300308. One example of an argon arc centrifugal casting machine is an argon arc centrifugal casting machine manufactured by O'Hara Co., Ltd of Osaka, Japan. One example of an arc-melting gas pressure casting machine is the AX-AWMAX1 arc-melting gas pressure casting machine manufactured by Tianjin Aixin Medical Equipment Co., Ltd in Tainjin, China 300308.

In one implementation of permanently fabricating one or more tooth-bonding-pads with the archwire at fixed positions of the archwire 2404, each of the plurality of tooth-bonding-pads (e.g. 104-130 in FIG. 1) are permanently fabricated to the archwire (e.g. archwire 102 in FIG. 1) through a welding/brazing process that is appropriate for the materials of the archwire and the tooth-bonding-pad(s). For example the tooth-bonding-pads are permanently fabricated to the archwire by sintering, laser welding, electrical resistance welding, tungsten inert gas welding or brazing/soldering. In some implementations of laser welding, crystals of yttrium, aluminum, garnet and neodymium emit laser beams. In some implementations of laser welding, gold alloys are laser welded to a cobalt-chromium alloy. In some implementations of tungsten inert gas welding, welding heat is produced by a light bow between tungsten anode and metal. In some implementations of brazing/soldering, the brazing/soldering is performed at more than 450 degrees C.

In one implementation of permanently fabricating one or more tooth-bonding-pads with the archwire at fixed positions of the archwire, each of the plurality of tooth-bonding-pads (e.g. 104-130 in FIG. 1) are permanently fabricated to the archwire (e.g. archwire 102 in FIG. 1) by welding.

In one implementation of permanently fabricating one or more tooth-bonding-pads with the archwire at fixed positions of the archwire 2404, each of the plurality of tooth-bonding-pads is glued onto the archwire at fixed positions of the archwire.

In one implementation of permanently fabricating 2404 one or more tooth-bonding-pads at fixed positions of the archwire, each of the plurality of tooth-bonding-pads is crimped onto the archwire at fixed positions of the archwire.

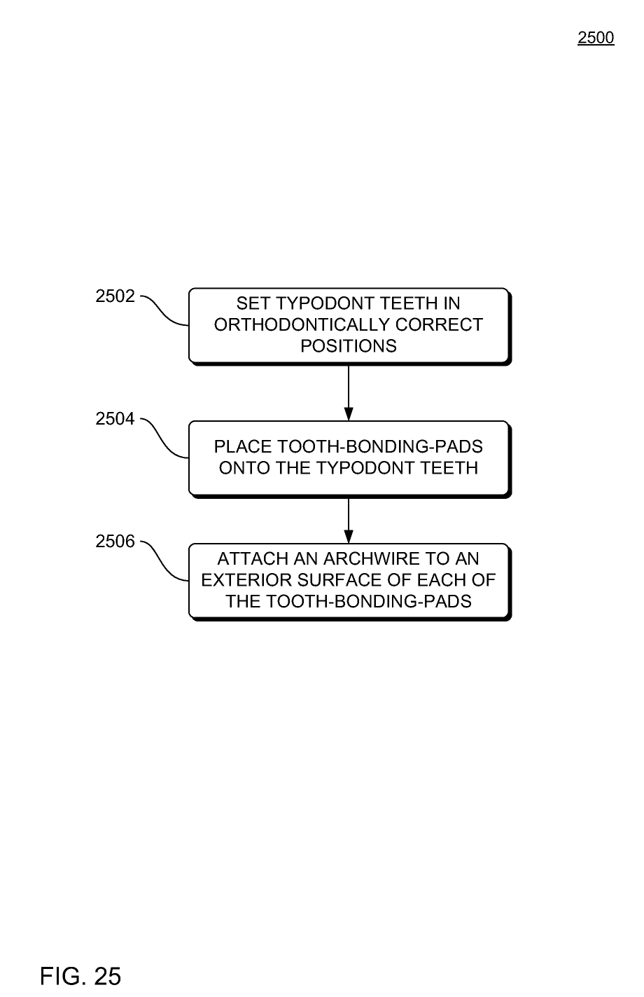

FIG. 25 is a flowchart of a method 2500 to fabricate a unitary tooth-bonding-pad/archwire apparatus, according to an implementation. In method 2500, at least one tooth-bonding-pad and an archwire are transformed into a unitary tooth-bonding-pad/archwire apparatus, such as apparatus 100, apparatus 200, apparatus 300, apparatus 600, apparatus 900 and apparatus 1200.

Method 2500 includes setting anatomically correct typodont teeth in orthodontically correct positions, at block 2502. Thereafter, anatomically contoured tooth-bonding-pads are placed onto labial or buccal surfaces of the typodont teeth in the occlusal-gingival center and mesial-distal center of the labial and buccal surface of orthodontically correct positions, at block 2504.

Method 2500 also includes attaching the archwire in an occlusal plane, passively contacting an exterior surface of each of the plurality of tooth-bonding-pads, and rigidly attaching the archwire to a midpoint of each of the corresponding plurality of tooth-bonding-pads, at block 2506.

FIG. 26 is a flowchart of a method 2600 to implement a unitary tooth-bonding-pad/archwire apparatus, according to an implementation before application of removable orthodontic appliance systems. Method 2600 provides effective treatment for orthodontic patients who are not originally practical candidates for removable orthodontic appliance systems.

At block 2602, if orthodontic malocclusion that is within the range that is conventionally diagnosed as treatable with removable applicant systems, then conventional treatment such as applying a conventional removable orthodontic appliance system to treat the malocclusion is performed at block 2604. However, if orthodontic malocclusion is outside of the range that is conventionally diagnosed as treatable with removable applicant systems, then at block 2606 in method 2600, an appropriately selected implementation of apparatus 100 is applied to a patient as an enabling appliance for orthodontic patients who, without prior treatment using apparatus 100, would not be practical candidates for complete and finishing orthodontic treatment with other removable orthodontic appliance systems. The appropriate implementation of apparatus 100 is based in part on the implementation variations described in FIG. 22 and FIG. 23. Some orthodontic patients who are not practical candidates for removable orthodontic appliance systems have less severe dental malocclusions and/or relapse of prior complete orthodontic treatment. Specifically, there are many cases of orthodontic malocclusion which cannot be fully treated with Invisalign® removable teeth aligner appliances alone. A significant number of patients having dental malocclusion can brought into the treatment range of Invisalign® removable teeth aligner appliances with a prior short-term application of apparatus 100. Additionally, many cases of malocclusion which are already treatable with Invisalign® removable teeth aligner appliances can be properly prepared for express treatment using Invisalign® removable teeth aligner appliances at a significantly overall reduced cost, and with less wear time by the patient.

After the application of apparatus 100 has achieved results that improve the prognosis for application of removable orthodontic appliance systems, apparatus 100 is removed from the patient, at block 2608, and then a conventional removable orthodontic realigner-retainer appliance system is applied to the patient, at block 2604.

FIG. 27 is a flowchart of a method 2700 to implement a unitary tooth-bonding-pad/archwire apparatus, to correct orthodontic relapse. Method 2700 provides effective treatment for orthodontic patients whose prior orthodontic treatment has relapsed or regressed.

If orthodontic relapse is not diagnosed, at block 2702, then conventional post-treatment retention is performed. However orthodontic relapse is diagnosed at block 2702, because the degree of relapse is outside the range of treatment of a conventional realigner-retainer appliance, an appropriately selected implementation of apparatus 100 is applied to the relapsed arches of the patient to bring the degree of orthodontic correction back within range of a realigner or a retainer, at block 2606. The appropriate implementation of apparatus 100 is based in part on the implementation variations described in FIG. 22 and FIG. 23.

After the application of apparatus 100 has achieved results that improve the prognosis for application of removable orthodontic appliance systems, apparatus 100 is removed from the patient, at block 2608, and the conventional orthodontic realigner/retainer appliance system is applied to the patient, at block 2706.

FIG. 28 is a flowchart of a method 2800 to implement a unitary tooth-bonding-pad/archwire apparatus, to facilitate the application of interceptive removable orthodontic devices on patients who are in a mixed dentition age range. Patients who are in a mixed dentition age range have one or more teeth are positioned such that the implementation of interceptive devices are be contraindicated, these problematically positioned teeth can be moved into positions by apparatus 100 to the extent that the new positions permit the implementation of these interceptive appliances.

When considering the use of a conventional interceptive orthodontic appliance for patients in the age range of mixed dentition if one or more malpositioned teeth contraindicate the use of conventional interceptive orthodontic appliances at block 2802, apparatus 100 can be applied to the patient, at block 2606, to bring the malpositioned teeth into positions that permit the use of the conventional interceptive orthodontic appliance on the patient. If the patient has no malpositioned teeth that contraindicate the use of the conventional interceptive orthodontic appliance, then the conventional interceptive orthodontic appliance is applied in a conventional manner, at block 2804.

After the application of apparatus 100 has achieved results that improve the prognosis for application of interceptive appliances, apparatus 100 is removed from the patient, at block 2608, and the interceptive appliance is applied to the patient, at block 2806.

Interceptive orthodontic appliances include Frankel orthodontic appliances, Schwarz orthodontic appliances and Bionator orthodontic appliances. Method 2800 provides effective treatment for orthodontic patients who are in a mixed dentition age range.

FIG. 29 is a flowchart of a method 2900 to implement a unitary tooth-bonding-pad/archwire apparatus, to correct a minor orthodontic malocclusion. Method 2900 provides effective treatment for orthodontic patients having a minor orthodontic malocclusion.

In method 2900, if a minor malocclusion in one or more arches is not diagnosed at block 2902, then no orthodontic treatment is performed at block 2904. However, if a minor malocclusion in one or more arches is diagnosed, at block 2902, in response to diagnosis of the minor orthodontic malocclusion, apparatus 100 is applied to the patient, at block 2606, to correct the minor orthodontic malocclusion. An example of a minor orthodontic malocclusion is a dental malocclusion that includes only minor tooth displacements, such as buccal-lingual displacements, rotations, tipping, and/or vertical height discrepancies.

After the application of apparatus 100 has corrected the minor orthodontic malocclusion, apparatus 100 is removed from the patient, at block 2608.

In some implementations, following completion of orthodontic treatment involving apparatus 100, any conventional orthodontic retainer, such as a Hawley orthodontic appliance, is applied to the patient at block 2906 to retain the orthodontic result.

FIG. 30 is a flowchart of a method 3000 to implement a unitary tooth-bonding-pad/archwire apparatus, in coordination with application of crowns and abutments.

Apparatus 100 can be implemented prior to crown and bridge work in dentistry. When one or more of teeth that are to be prepared for crowns or as abutments for bridgework are in less than ideal positions, apparatus 100 can be implemented to better position these teeth for stress bearing associated with chewing forces, and also to allow for a more aesthetically appearing cosmetic result. For example, for teeth which are tipped or displaced from ideal positions of the teeth, orthodontic correction toward ideal positions of the teeth would permit the forces of mastication to be correctly directed along the long axis of the tooth, instead of producing periodontally unhealthy excessive lateral force components. Also, when anterior crowns are applied, significant labial-lingual misalignment can often be greater than can be compensated by selective tooth reduction alone. When the labial-lingual misalignment is greater than can be compensated by selective tooth reduction alone, short term correction involving apparatus 100 aligns the anterior teeth so that conservative crown preparation will allow for a cosmetically ideal result.

If conventional preparation of a crown or a bridge is not contra-indicated because of tooth misalignment, at block 3002, the conventional preparation of a crown or bridge without using apparatus 100 is performed, at block 3004. However, if conventional preparation of a crown or a bridge is contra-indicated because of tooth misalignment, at block 3002, then an appropriately selected implementation of apparatus 100 is applied to the patient to better position the teeth for stress bearing associated with chewing force, at block 2606.

After the application of apparatus 100 has achieved results that improve the prognosis for application of crowns and/or bridges, apparatus 100 is removed from the patient and the tooth or teeth are conventionally prepared for an ideal crown or bridge result and a temporary crown or bridge coverage is applied based on conventional techniques, at block 2608, and conventional preparation of a crown or bridge without using apparatus 100 is performed, at block 3004.

The methods disclosed herein do not include attaching or including a bracket to the apparatus.

### Conclusion

A unitary tooth-bonding-pad/archwire system that does not include an orthodontic bracket is described herein.

In one implementation, a plurality of orthodontic archwires each have tooth bonding pads attached in specified locations. Five archwires of standardized archform geometry for the maxillary arch for each specified diameter or cross-section, and five archwires of standardized archform geometry for the mandibular arch for each specified diameter or cross section. As there are four specified diameters or cross-sections of archwires for each of the five standardized archform geometries, a total of twenty archwires can be fabricated for the upper arch, and a total of twenty archwires can be fabricated for the lower arch. Each archwire has a dental midline marking.

Although specific implementations are illustrated and described herein, it will be appreciated by those of ordinary skill in the art that any arrangement which is calculated to achieve the same purpose may be substituted for the specific implementations shown. This disclosure is intended to cover any adaptations or variations. For example, one of ordinary skill in the art will appreciate that implementations can be made in any material or any other process that provides the required function.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices can be introduced without departing from the scope of implementations. One of skill in the art will readily recognize that implementations are applicable to new archwires and different tooth-bonding-pads.

The terminology in this disclosure is meant to include all archwires and tooth-bonding pads and alternate technologies which provide the same functionality as described herein.

In some aspects, an apparatus consists of an archwire and a plurality of tooth-bonding-pads in which each of the plurality of tooth-bonding-pads are permanently fabricated to the archwire at fixed positions of the archwire. In some implementations, each of the plurality of tooth-bonding-pads that is permanently fabricated to the archwire includes at least one of the plurality of tooth-bonding-pads that are formed as one complete integral unit with the archwire. In some implementations, each of the plurality of tooth-bonding-pads that is permanently fabricated to the archwire includes at least one of the plurality of tooth-bonding-pads being permanently fabricated to the archwire through a welding/brazing method that is appropriate for the materials of the archwire and the tooth-bonding-pad. In some implementations, each of the plurality of tooth-bonding-pads that is permanently fabricated to the archwire includes at least one of the plurality of tooth-bonding-pads being welded to the archwire. In some implementations, each of the plurality of tooth-bonding-pads that is permanently fabricated to the archwire at fixed positions of the archwire includes at least one of the plurality of tooth-bonding-pads being metallurgically permanently fabricated to the archwire at fixed positions of the archwire. In some implementations, each of the plurality of tooth-bonding-pads that is permanently fabricated to the archwire at fixed positions of the archwire includes at least one of the plurality of tooth-bonding-pads are glued to the archwire at fixed positions of the archwire. In some implementations, the plurality of tooth-bonding-pads are 14 tooth-bonding-pads. In some implementations, each of the tooth-bonding-pads have an orientation to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads include providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations the apparatus is produced by a method including setting typodont teeth in orthodontically correct positions; placing the tooth-bonding-pads onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, each of the tooth-bonding-pads include at least one contour of each of the tooth-bonding-pads is produced from existing statistical norms of the labial and buccal surfaces of human teeth. In some implementations, each of the tooth-bonding-pads include an occlusal-gingival height in a range of 1.5 mm to 4 mm and a mesial-distal length in a range of 1.5 mm to 3.0 mm. In some implementations, the archwire includes thermally activated nickel-titanium (NiTi) metal. In some implementations, the thermally activated nickel-titanium (NiTi) metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces. In some implementations, each of the plurality of tooth-bonding-pads that is permanently fabricated to the archwire includes each of the plurality of tooth-bonding-pads being permanently fabricated onto the archwire. In some implementations, each of the plurality of tooth-bonding-pads that is permanently fabricated to the archwire includes each of the plurality of tooth-bonding-pads being permanently fabricated into the archwire.

In some aspects, an apparatus consists essentially of an archwire, and a plurality of tooth-bonding-pads each of the plurality of tooth-bonding-pads is permanently fabricated into the archwire at fixed positions of the archwire. In some implementations, each of the plurality of tooth-bonding-pads that is permanently fabricated into the archwire includes at least one of the plurality of tooth-bonding-pads that are formed as one complete integral unit with the archwire. In some implementations, each of the plurality of tooth-bonding-pads that is permanently fabricated into the archwire includes at least one of the plurality of tooth-bonding-pads are permanently fabricated to the archwire through a welding/brazing method that is appropriate for the materials of the archwire and the tooth-bonding-pad. In some implementations, each of the plurality of tooth-bonding-pads that is permanently fabricated into the archwire includes at least one of the plurality of tooth-bonding-pads being welded to the archwire. In some implementations, each of the plurality of tooth-bonding-pads that is permanently fabricated into the archwire at fixed positions of the archwire includes at least one of the plurality of tooth-bonding-pads are metallurgically permanently fabricated into the archwire at fixed positions of the archwire. In some implementations, each of the plurality of tooth-bonding-pads that is permanently fabricated into the archwire at fixed positions of the archwire includes at least one of the plurality of tooth-bonding-pads are glued onto the archwire at fixed positions of the archwire. In some implementations, the plurality of tooth-bonding-pads are 14 tooth-bonding-pads. In some implementations, each of the tooth-bonding-pads have an orientation to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads include providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations the apparatus is produced by a method including setting typodont teeth in orthodontically correct positions; placing the tooth-bonding-pads onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, each of the tooth-bonding-pads include at least one contour of each of the tooth-bonding-pads is produced from existing statistical norms of the labial and buccal surfaces of human teeth. In some implementations, each of the tooth-bonding-pads include an occlusal-gingival height in a range of 1.5 mm to 4 mm and a mesial-distal length in a range of 1.5 mm to 3.0 mm. In some implementations, the archwire includes thermally activated nickel-titanium (NiTi) metal, with force activation occurring at approximately 27 degrees Celsius and approximately 81 degrees Fahrenheit. In some implementations, the archwire includes a diameter selected from the group of diameters consisting of 0.012 inches in diameter round, 0.014 inches in diameter round, 0.016 round, and 0.016×0.0016 inches rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces. In some implementations, each of the plurality of tooth-bonding-pads that is permanently fabricated to the archwire includes each of the plurality of tooth-bonding-pads being permanently fabricated onto the archwire. In some implementations, each of the plurality of tooth-bonding-pads that is permanently fabricated to the archwire includes each of the plurality of tooth-bonding-pads being permanently fabricated into the archwire.

In some aspects, an apparatus includes an archwire, and a plurality of tooth-bonding-pads each of the plurality of tooth-bonding-pads is permanently fabricated to the archwire at fixed positions of the archwire. In some implementations, each of the plurality of tooth-bonding-pads that is permanently fabricated into the archwire includes each of the plurality of tooth-bonding-pads is formed as one complete integral unit with the archwire. In some implementations, each of the plurality of tooth-bonding-pads that is permanently fabricated into the archwire includes each of the plurality of tooth-bonding-pads is formed as one complete integral unit with the archwire. In some implementations, each of the plurality of tooth-bonding-pads that is permanently fabricated into the archwire includes each of the plurality of tooth-bonding-pads being permanently fabricated to the archwire through a welding/brazing method that is appropriate for the materials of the archwire and the tooth-bonding-pad. In some implementations, each of the plurality of tooth-bonding-pads that is permanently fabricated into the archwire includes each of the plurality of tooth-bonding-pads being welded to the archwire. In some implementations, the apparatus includes not having an orthodontic bracket. In some implementations, each of the plurality of tooth-bonding-pads that is permanently fabricated into the archwire at fixed positions of the archwire includes each of the plurality of tooth-bonding-pads being metallurgically permanently fabricated into the archwire at fixed positions of the archwire. In some implementations, each of the plurality of tooth-bonding-pads that is permanently fabricated into the archwire at fixed positions of the archwire includes each of the plurality of tooth-bonding-pads being glued onto the archwire at fixed positions of the archwire. In some implementations, the plurality of tooth-bonding-pads are 14 tooth-bonding-pads. In some implementations, each of the tooth-bonding-pads have an orientation to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads include providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations the apparatus is produced by a method including setting typodont teeth in orthodontically correct positions; placing the tooth-bonding-pads onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, each of the tooth-bonding-pads include at least one contour of each of the tooth-bonding-pads is produced from existing statistical norms of the labial and buccal surfaces of human teeth. In some implementations, each of the tooth-bonding-pads include an occlusal-gingival height in a range of 1.5 mm to 4 mm and a mesial-distal length in a range of 1.5 mm to 3.0 mm. In some implementations, the archwire includes thermally activated nickel-titanium (NiTi) metal. In some implementations, the thermally activated nickel-titanium (NiTi) metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces. In some implementations, each of the plurality of tooth-bonding-pads that is permanently fabricated to the archwire includes each of the plurality of tooth-bonding-pads being permanently fabricated onto the archwire. In some implementations, each of the plurality of tooth-bonding-pads that is permanently fabricated to the archwire includes each of the plurality of tooth-bonding-pads being permanently fabricated into the archwire.

In some aspects, an apparatus consists of an archwire, and at least one tooth-bonding-pad directly attached to the archwire. In some implementations, the at least one tooth-bonding-pad directly attached to the archwire includes the at least one tooth-bonding-pad is formed as one complete integral unit with the archwire. In some implementations, the at least one tooth-bonding-pad directly attached to the archwire includes the at least one tooth-bonding-pad is attached directly to the archwire through welding/brazing. In some implementations, the at least one tooth-bonding-pad directly attached to the archwire includes the at least one tooth-bonding-pad is welded to the archwire. In some implementations, the at least one tooth-bonding-pad directly attached to the archwire includes the at least one tooth-bonding-pad is metallurgically permanently fabricated into the archwire at fixed positions of the archwire. In some implementations, the at least one tooth-bonding-pad directly attached to the archwire includes the at least one tooth-bonding-pad is glued onto the archwire at fixed positions of the archwire. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of the human teeth. In some implementations, the orientation of the at least one tooth-bonding-pad includes providing the at least one tooth-bonding-pad is accurately appositioned with labial and buccal aspects at occlusal-gingival center and mesial-distal center to the extent that human teeth that are not in orthodontically correct positions will experience corrective orthodontic forces moving the human teeth toward orthodontically correct positions. In some implementations the apparatus is produced by a method including setting typodont teeth in orthodontically correct positions; placing the at least one tooth-bonding-pad onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the at least one tooth-bonding-pad includes a tooth-color as a result of manufacturing with epoxy coatings or other tooth-colored surfaces. In some implementations, the archwire includes thermally activated nickel-titanium (NiTi) metal. In some implementations, the thermally activated nickel-titanium (NiTi) metal includes force activation occurring at a temperature of approximately 27 degrees Celsius. In some implementations, the archwire includes a diameter selected from the group of diameters consisting of 0.012 round, 0.014 inches in diameter round, 0.016 inches in diameter round, and 0.016×0.016 inches rectangular cross section. In some implementations, the archwire includes a tooth-color as a result of manufacturing with epoxy coatings or other tooth-colored surfaces.

In some aspects, an apparatus consists essentially of an archwire, and at least one tooth-bonding-pad directly attached to the archwire. In some implementations, the at least one tooth-bonding-pad directly attached to the archwire includes the at least one tooth-bonding-pad is formed as one complete integral unit with the archwire. In some implementations, the at least one tooth-bonding-pad directly attached to the archwire includes the at least one tooth-bonding-pad is directly attached to the archwire through a welding/brazing method that is appropriate for the materials of the archwire and the tooth-bonding-pad. In some implementations, the at least one tooth-bonding-pad directly attached to the archwire includes the at least one tooth-bonding-pad is welded to the archwire. In some implementations, the at least one tooth-bonding-pad directly attached to the archwire includes the at least one tooth-bonding-pad is metallurgically permanently fabricated into the archwire at fixed positions of the archwire. In some implementations, the at least one tooth-bonding-pad directly attached to the archwire includes the at least one tooth-bonding-pad is glued onto the archwire at fixed positions of the archwire. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of human teeth. In some implementations, the orientation of the at least one tooth-bonding-pad includes providing the at least one tooth-bonding-pad is accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations the apparatus is produced by a method including setting typodont teeth in orthodontically correct positions; placing the at least one tooth-bonding-pad onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the archwire includes thermally activated nickel-titanium (NiTi) metal, with force activation occurring at approximately 27 degrees Celsius and approximately 81 degrees Fahrenheit. In some implementations, the archwire includes a diameter selected from the group of diameters consisting of 0.012 inches in diameter round, 0.014 inches in diameter round, 0.016 inches in diameter round, and 0.016×0.016 rectangular cross section. In some implementations, the archwire includes a tooth-color as a result of manufacturing with epoxy coatings or other tooth-colored surfaces. In some implementations, the at least one tooth-bonding-pad includes a tooth-color as a result of manufacturing with epoxy coatings or other tooth-colored surfaces.

In some aspects, an apparatus includes an archwire, and at least one tooth-bonding-pad directly attached to the archwire. In some implementations, the at least one tooth-bonding-pad directly attached to the archwire includes the at least one tooth-bonding-pad is formed as one complete integral unit with the archwire. In some implementations, the at least one tooth-bonding-pad directly attached to the archwire includes the at least one tooth-bonding-pad is formed as one complete integral unit with the archwire. In some implementations, the at least one tooth-bonding-pad directly attached to the archwire includes the at least one tooth-bonding-pad is permanently fabricated to the archwire through a welding/brazing method that is appropriate for the materials of the archwire and the tooth-bonding-pad. In some implementations, the at least one tooth-bonding-pad directly attached to the archwire includes the at least one tooth-bonding-pad is welded to the archwire. In some implementations, the apparatus includes not having an orthodontic bracket. In some implementations, the at least one tooth-bonding-pad directly attached to the archwire includes the at least one tooth-bonding-pad is metallurgically permanently fabricated into the archwire at fixed positions of the archwire. In some implementations, the at least one tooth-bonding-pad directly attached to the archwire includes the at least one tooth-bonding-pad is glued onto the archwire at fixed positions of the archwire. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of the human teeth. In some implementations, the orientation of the at least one tooth-bonding-pad includes providing the at least one tooth-bonding-pad is accurately appositioned with labial and buccal aspects at occlusal-gingival center and mesial-distal center to the extent that human teeth that are not in orthodontically correct positions will experience corrective orthodontic forces moving the human teeth toward orthodontically correct positions. In some implementations the apparatus is produced by a method including setting typodont teeth in orthodontically correct positions; placing the at least one tooth-bonding-pad onto the typodont teeth in the occlusal-gingival center and mesial-distal center of the labial and buccal aspect of orthodontically correct positions; and attaching the archwire in a horizontal plane, to an exterior surface of each of the plurality of tooth-bonding-pads. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the at least one tooth-bonding-pad includes a tooth-color as a result of manufacturing with epoxy coatings or other tooth-colored surfaces. In some implementations, the archwire includes thermally activated nickel-titanium (NiTi) metal. In some implementations, the thermally activated nickel-titanium (NiTi) metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches rectangular cross section. In some implementations, the archwire includes a tooth-color as a result of manufacturing with epoxy coatings or other tooth-colored surfaces.

In some aspects, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and attaching permanently an archwire to the exterior surface of each of the plurality of the tooth-bonding-pads in a plane. In some implementations, the method includes not attaching an orthodontic bracket. In some implementations, the method includes attaching permanently the archwire to the exterior surface of each of the plurality of the tooth-bonding-pads includes forming the archwire as one complete integral unit with the plurality of tooth-bonding-pads. In some implementations, the method includes attaching permanently the archwire to the exterior surface of each of the plurality of the tooth-bonding-pads includes welding/brazing the archwire to the exterior surface of each of the plurality of the tooth-bonding-pads In some implementations, the method includes attaching permanently the archwire to the exterior surface of each of the plurality of the tooth-bonding-pads includes welding each of the plurality of tooth-bonding-pads to the archwire. In some implementations, the method includes attaching permanently the archwire to the exterior surface of each of the plurality of the tooth-bonding-pads includes fabricating metallurgically the archwire into each of the plurality of tooth-bonding-pads. In some implementations, the method includes attaching permanently the archwire to the exterior surface of each of the plurality of the tooth-bonding-pads includes gluing the archwire to each of the plurality of tooth-bonding-pads. In some implementations, the method includes the plurality of tooth-bonding-pads includes 14 tooth-bonding-pads. In some implementations, the method includes an orientation of each of the tooth-bonding-pads to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the method includes the orientation of each of the tooth-bonding-pads include providing the tooth-bonding-pads as accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, the method includes producing at least one contour of each of the tooth-bonding-pads based on existing statistical norms of the labial and buccal surfaces of human teeth. In some implementations, the method includes each of the tooth-bonding-pads include an occlusal-gingival height in a range of 1.5 mm to 4 mm and a mesial-distal length in a range of 1.5 mm to 3.0 mm. In some implementations, the method includes the archwire includes thermally activated nickel-titanium (NiTi) metal. In some implementations, the thermally activated nickel-titanium (NiTi) metal includes force activation occurring at a temperature of approximately 27 degrees Celsius. In some implementations, the method includes the archwire includes a diameter selected from the group of diameters consisting of 0.012 inches in diameter round, 0.014 inches in diameter round, 0.016 inches in diameter round, and 0.016×0.016 inches rectangular cross section. In some implementations, the method includes the archwire includes a tooth-color as a result of manufacturing with epoxy coatings or other tooth-colored surfaces. In some implementations, the method includes the at least one of the plurality of tooth-bonding-pads includes a tooth-color as a result of manufacturing with epoxy coatings or other tooth-colored surfaces.

In some aspects, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and forming an archwire to an exterior surface of each of the plurality of the tooth-bonding-pads in a horizontal plane. In some implementations, the method includes not attaching an orthodontic bracket. In some implementations, the method includes forming an archwire to an exterior surface of each of the plurality of the tooth-bonding-pads includes forming the archwire as one complete integral unit with the plurality of tooth-bonding-pads. In some implementations, the method includes forming an archwire to an exterior surface of each of the plurality of the tooth-bonding-pads includes welding/brazing the archwire to the exterior surface of each of the plurality of the tooth-bonding-pads In some implementations, the method includes forming an archwire to an exterior surface of each of the plurality of the tooth-bonding-pads includes welding each of the plurality of tooth-bonding-pads to the archwire. In some implementations, the method includes forming an archwire to an exterior surface of each of the plurality of the tooth-bonding-pads includes fabricating metallurgically the archwire into each of the plurality of tooth-bonding-pads. In some implementations, the method includes forming an archwire to an exterior surface of each of the plurality of the tooth-bonding-pads includes gluing the archwire to each of the plurality of tooth-bonding-pads. In some implementations of the method the plurality of tooth-bonding-pads includes 14 tooth-bonding-pads. In some implementations of the method includes an orientation of each of the tooth-bonding-pads to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations of the method includes providing the tooth-bonding-pads as accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, the method includes producing at least one contour of each of the tooth-bonding-pads based on existing statistical norms of the labial and buccal surfaces of human teeth. In some implementations of the method, each of the tooth-bonding-pads include an occlusal-gingival height in a range of 1.5 mm to 4 mm and a mesial-distal length in a range of 1.5 mm to 3.0 mm. In some implementations of the method the archwire includes a thermally activated nickel-titanium (NiTi) metal, with force activation occurring at approximately 27 degrees Celsius and approximately 81 degrees Fahrenheit. In some implementations of the method the archwire includes a diameter selected from the group of diameters consisting of 0.012 inches in diameter round, 0.014 inches in diameter round, 0.016 inches in diameter round, and 0.016×0.016 inches rectangular cross section. In some implementations of the method the archwire includes a tooth-color as a result of manufacturing with epoxy coatings or other tooth-colored surfaces. In some implementations of the method the at least one of the plurality of tooth-bonding-pads includes a tooth-color as a result of manufacturing with epoxy coatings or other tooth-colored surfaces.

In some implementations, apparatus that consists of the archwire and the plurality of tooth-bonding-pads include only the major components the archwire and the plurality of tooth-bonding-pads. An attachment apparatus is not a major component of the apparatus but merely provides a manner of attaching the archwire to the plurality of tooth-bonding-pads without a major structural component in between the archwire and the plurality of tooth-bonding-pads.

In some implementations, apparatus that consists essentially of the archwire and the plurality of tooth-bonding-pads excludes additional limitations that materially affect the basic characteristic of the archwire and the plurality of tooth-bonding-pads. An attachment apparatus is not a major component of the apparatus but merely provides a manner of attaching the archwire to the plurality of tooth-bonding-pads without a major structural component in between the archwire and the plurality of tooth-bonding-pads.

In some of the implementations of permanent attachment, the permanent attachment is a semi-permanent attachment, such as a removable attachment.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. An apparatus consisting essentially of:
an archwire; and
a plurality of tooth-bonding-pads, wherein each of the plurality of tooth-bonding-pads is permanently fabricated to the archwire at fixed positions of the archwire.

21. (canceled)

22. The apparatus of claim 20, wherein each of the plurality of tooth-bonding-pads being permanently fabricated into the archwire further comprises:
at least one of the plurality of tooth-bonding-pads are permanently fabricated to the archwire through a welding/brazing method that is appropriate for the materials of the archwire and the tooth-bonding-pad.

23. (canceled)

24. (canceled)

25. (canceled)

26. (canceled)

27. The apparatus of claim 20, wherein each of the tooth-bonding-pads further comprise:
an orientation of each of the tooth-bonding-pads to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth.

28. (canceled)

29. (canceled)

30. (canceled)

31. (canceled)

32. The apparatus of claim 20, wherein the archwire further comprises:
thermally activated nickel-titanium metal, with force activation occurring at approximately 27 degrees Celsius and approximately 81 degrees Fahrenheit.

33. (canceled)

34. (canceled)

35. (canceled)

36. The apparatus of claim 20, wherein each of the plurality of tooth-bonding-pads being permanently fabricated to the archwire further comprises:
each of the plurality of tooth-bonding-pads is permanently fabricated onto the archwire.

37. The apparatus of claim 20, wherein each of the plurality of tooth-bonding-pads being permanently fabricated to the archwire further comprises:
each of the plurality of tooth-bonding-pads is permanently fabricated into the archwire.

38. An apparatus comprising:
an archwire; and
a plurality of tooth-bonding-pads, wherein each of the plurality of tooth-bonding-pads is permanently fabricated to the archwire at fixed positions of the archwire.

39. (canceled)

40. (canceled)

41. The apparatus of claim 38, wherein each of the plurality of tooth-bonding-pads being permanently fabricated into the archwire further comprises:
each of the plurality of tooth-bonding-pads is permanently fabricated to the archwire through a welding/brazing method that is appropriate for the materials of the archwire and the tooth-bonding-pad.

42. (canceled)

43. (canceled)

44. (canceled)

45. (canceled)

46. The apparatus of claim 38, wherein the plurality of tooth-bonding-pads further comprise:
14 tooth-bonding-pads.

47. The apparatus of claim 38, wherein each of the tooth-bonding-pads further comprise:
an orientation of each of the tooth-bonding-pads to the archwire such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth.

48. (canceled)

49. (canceled)

50. (canceled)

51. (canceled)

52. The apparatus of claim 38, wherein the archwire further comprises:
thermally activated nickel-titanium metal.

53. (canceled)

54. (canceled)

55. (canceled)

56. (canceled)

57. The apparatus of claim 38, wherein each of the plurality of tooth-bonding-pads being permanently fabricated to the archwire further comprises:
each of the plurality of tooth-bonding-pads is permanently fabricated onto the archwire.

58. The apparatus of claim 38, wherein each of the plurality of tooth-bonding-pads being permanently fabricated to the archwire further comprises:
each of the plurality of tooth-bonding-pads is permanently fabricated into the archwire.

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. An apparatus comprising:
an archwire; and
at least two tooth-bonding-pads directly attached to the archwire.

93. (canceled)

94. (canceled)

95. The apparatus of claim 92, wherein the at least two tooth-bonding-pads directly attached to the archwire further comprises:
the at least two tooth-bonding-pads is permanently fabricated to the archwire through a welding/brazing method that is appropriate for the materials of the archwire and the tooth-bonding-pad.

96. (canceled)

97. The apparatus of claim 92, wherein the apparatus further comprises:
not having an orthodontic bracket.

98. (canceled)

99. (canceled)

100. The apparatus of claim 92, wherein the at least two tooth-bonding-pads further comprises:
14 tooth-bonding-pads.

101. The apparatus of claim 92, wherein the at least two tooth-bonding-pads further comprises:
an orientation of the at least two tooth-bonding-pads to the archwire is such that when the at least two tooth-bonding-pads is applied to human teeth that are in orthodontically correct positions in all three planes of space, contours of exterior surfaces of the at least two tooth-bonding-pads accurately apposition with the occlusal-gingival center and the mesial-distal center of the labial and buccal contours of the human teeth.

102. (canceled)

103. (canceled)

104. The apparatus of claim 92, wherein the at least two tooth-bonding-pads further comprises:
at least one contour of the at least two tooth-bonding-pads being produced from existing statistical norms of the labial and buccal surfaces of human teeth.

105. (canceled)

106. (canceled)

107. The apparatus of claim 92, wherein the archwire further comprises:
thermally activated nickel-titanium metal.

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)
